(19) United States
(12) Patent Application Publication
(10) Pub. No.: US 2005/0179632 A1
(43) Pub. Date: Aug. 18, 2005

(54) Display element and display apparatus

(75) Inventors: Koichi Miyachi, Soraku-gun (JP); Seiji Shibahara, Tenri-shi (JP); Iichiro Inoue, Tenri-shi (JP); Shoichi Ishihara, Katano-shi (JP); Takako Koide, Kashihara-shi (JP); Kiyoshi Ogishima, Soraku-gun (JP); Akihito Jinda, Kitakatsuragi-gun (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/038,582

(22) Filed: Jan. 21, 2005

(30) Foreign Application Priority Data
Jan. 20, 2004 (JP) 2004-012206
Jan. 7, 2005 (JP) 2005-003221

(51) Int. Cl. G09G 3/36

(52) U.S. Cl. 345/87

(57) ABSTRACT

A display element includes: a pair of substrates, at least one of which is transparent; a medium, between the substrates, the medium being changeable in an optical anisotropy magnitude by and according to electric field application; and a region in which a pixel electrode and a counter electrode overlap with each other with an insulating layer therebetween.

This Nonprovisional application claims priority under 35 U.S.C. § 119(a) on Patent Applications Nos. 2004/012206 and 2005/003221 filed in Japan respectively on Jan. 20, 2004, and on Jan. 7, 2005, the entire contents of which are hereby incorporated by reference.

### FIELD OF THE INVENTION

The present invention relates to a display element having a high-speed response property, a wide viewing angle property, and a high display quality.

### BACKGROUND OF THE INVENTION

A liquid crystal display element has advantages over other display elements in terms of thickness, weight, and power consumption, and is therefore widely used for image display apparatuses such as a television set or a monitor; and image display apparatuses provided in: OA (Office Automation) devices such as a word processor or a personal computer; video cameras; digital cameras; and information terminals such as a mobile phone.

There are conventionally well-known liquid crystal display modes for the liquid crystal display element, such as the TN (twisted nematic) mode using nematic liquid crystal, the display mode using FLC (ferroelectric liquid crystal) or AFLC (anti-ferroelectric liquid crystal), and the polymer dispersed liquid crystal display mode.

Among the liquid crystal display modes, for example, liquid crystal display elements adopting the TN mode have conventionally been put to actual applications. However, the liquid crystal display adopting the TN mode has drawbacks of slow response and narrow viewing angle. These disadvantages have prevented the TN mode liquid crystal display from taking over the CRT (Cathode Ray Tube).

The display mode using the FLC or AFLC allows for high-speed response and wide viewing angle, but its poor shock resistance and poor temperature characteristics pose serious drawbacks. This is one reason why the FLC or AFLC display mode is not pervasive.

The polymer dispersed liquid crystal display mode employing light scattering does not need a polarizing plate, and allows for high-luminance display. However, in the polymer dispersed liquid crystal display mode, it is intrinsically impossible to control the viewing angle with the use of a phase plate. Further, the polymer dispersed liquid crystal display mode has a problem in its response property. Therefore, the polymer dispersed liquid crystal display mode has only a few advantages over the TN mode.

In any of these display modes, liquid crystal molecules are aligned in a certain direction, and visibility depends on an angle with respect to the liquid crystal molecules. That is, there is a limitation in the viewing angle. Further, all of the display modes employ rotation of liquid crystal molecules caused by electric field application. Because the liquid crystal molecules rotate all together in an aligned state, a response speed is slow. Although the display mode using FLC or AFLC has advantages in its response speed and viewing angle, the mode has a problem of irreversible alignment breakdown due to external force.

Apart from the display elements employing the molecule rotation due to the application of the electric field voltage, an electronic polarization display mode using the quadratic electro-optic effect has been proposed.

The electro-optic effect refers to a phenomenon in which a reflective index of a material varies according to an external electric field. There are two types of electro-optic effects: (i) the Pockels effect in which a reflective index of a material is proportional to the electric field, and (ii) the Kerr effect in which a reflective index of a material is proportional to the square of the electric field. Especially, the Kerr effect, which is the quadratic electro-optic effect, has been applied to high-speed optical shutters since early days, and has been put to practical applications in the field of special measuring instruments.

The Kerr effect was found by J. Kerr in 1875. Well-known materials showing the Kerr effect are organic liquids such as nitrobenzene, carbon disulfide, and the like. These materials are used for, for example, optical shutters, optical modulating devices, and polarizing devices. They are also used for the strength measurement of a strong electric field, for example, for power cables.

Later, liquid crystal materials were found to have large Kerr constants, which called for the basic study looking into the possibility of using such liquid crystal materials in light modulation devices, polarizing devices, and even optical integrated circuit. It has been reported that some liquid crystal compounds have a Kerr constant more than 200 times greater than that of nitrobenzene.

Under these circumstances, application of the Kerr effect to a display apparatus has come to be studied. Because the Kerr effect is proportional to the square of the electric field, it is expected that the Kerr effect will allow the display apparatus to be driven at a relatively lower voltage than that allowed by the Pockels effect. Further, since the Kerr effect intrinsically has response characteristics on the order of several microseconds to several milliseconds, application of the Kerr effect to fast-response display apparatus is expected.

For example, disclosed in patent document 1 (Japanese Laid-Open Patent Publication No. 249363/2001 (Tokukai 2001-249363; published on Sep. 14, 2001)) is a display apparatus using the Kerr effect, which includes: (i) a pair of substrates, at least one of which is transparent; (ii) a medium that is interposed between the substrates, and that contains polar molecules in an isotropic phase state; (iii) a polarizing plate provided on an outer side of at least one of the substrates; and (iv) electric field applying means for applying an electric field to the medium.

### SUMMARY OF THE INVENTION

However, the display element using a material whose optical anisotropy varies according to an applied electric field has the following problems. That is, in the case where the display element is addressed with a switching element for use in ordinary liquid crystal display elements, reduction of transmittance and uneven luminance occur in the display element. Further, in this case, the display element cannot quickly respond to a signal voltage applied through the switching element, thereby causing a delay in image display. Note that the term “signal voltage” means a voltage to be written (charged) in the display element by the switching element so as to drive the display element.

Driving is carried out with a switching element such as a FET (field effect transistor) provided in the display element. Specifically, a voltage outputted by a voltage waveform generator is applied to the display element to charge the display element when the switching element is switched ON. The stored charge in the display element remains even when the switching element is switched OFF.

The display element starts being charged when the switching element is switched ON when a voltage having been generated by the voltage waveform generator is available for the charging. Ideally the stored charge in the display element remains constant even after the switching element is switched OFF.

However, in a medium whose optical anisotropy varies according to an applied electric field, the stored charge in the display element does not stay constant after the switching element is switched OFF. This is because such a medium is apt to be contaminated with impurity ions. As the impurity ion concentration of the medium increases, specific resistance of the medium decreases. Accordingly, the charge stored in a pixel capacitor via the switching element continues to decrease even after the switching element is switched OFF, with the result that the voltage in the pixel is reduced. This decreases luminance. Moreover, because the specific resistance is decreased unevenly in the screen, the luminance becomes uneven on the screen.

Further, another problem arises when driving the display element that uses a medium whose optical anisotropy varies according to an applied electric field, and that is provided with a switching element for use in ordinary liquid crystal display elements. That is, even if a constant signal voltage is written (charged) in the display element, the actual transmittance response waveform of the display element increases stepwise. Specifically, the medium assumes highly ordered alignment as the voltage increases, and as a result the pixel capacitance is increased. In other words, because the pixel capacitance increases during the voltage application, the voltage calculated at the time of voltage application is insufficient to give a target voltage value to the pixel.

Accordingly, the time required for the display element to respond to the signal voltage becomes longer than one frame period. This causes deterioration of display quality, such as afterimage in moving images.

An object of the present invention is to provide a display apparatus that can display a high-quality image with quick response even when the display apparatus is driven with a switching element provided for each pixel.

A display element of the present invention includes: a pair of substrates, at least one of which is transparent; a medium, between the substrates, the medium being changeable in an optical anisotropy magnitude by and according to electric field application; and a region in which a pixel electrode and a counter electrode overlap with each other with an insulating layer therebetween.

Because the conventional liquid crystal display element performs its display operation by utilizing a change in magnitude of an orientational directions of liquid crystal molecules, the response speed of the conventional liquid crystal display element is greatly influenced by intrinsic viscosity of liquid crystal. On the contrary, the aforementioned arrangement utilizes the change in the magnitude of the optical anisotropy in the medium so as to carry out a display. For this reason, the response speed is not greatly influenced by the intrinsic viscosity of the liquid crystal unlike the conventional display element. Therefore, the display element intrinsically has a high-speed response property.

However, the display element of the above arrangement has capacitance that monotonously increases as a voltage increases. In this case, a voltage in the display element does not immediately (for example, within one frame) reach a desired voltage, which should reach in response to the voltage application. This causes a problem such as an afterimage in a moving image. Therefore, by providing a region in which the pixel electrode and the counter electrode overlap with each other with the insulating layer therebetween, an auxiliary capacitor is formed parallel to the capacitor of the display element. This can reduce degree of a change in entire capacitance of the display element. This arrangement causes the auxiliary capacitor to be formed parallel to the capacitor of the display element in the equivalent circuit. As a result, the degree of the change in the entire capacitance of the display element becomes relatively smaller. This prevents the problem such as the afterimage in the moving image.

With the arrangement, a display apparatus including the display element never loses the high-speed response property faster than the response property of the conventional liquid crystal display elements. This allows more secure realization of the high-speed response of the display element that carries out a display by using the change of the medium in terms of magnitude of optical anisotropy.

Moreover, in the medium of the display element of the arrangement, impurity ion concentration is apt to increase. This decreases specific resistance of the medium. Low specific resistance of the medium decreases luminance of the display element. Moreover, because the specific resistance decreases unevenly on a screen, the luminance accordingly becomes uneven on the screen. However, in the case where the auxiliary capacitor is formed as in the arrangement, it is possible to supply, from the auxiliary capacitor to the medium, an electric charge that corresponds to an electric charge in short (that is, the auxiliary capacitor can supply, to the medium of a part of the screen with which the auxiliary capacitor is associated, electric charge necessary for making up for short of electric charge in the medium). This apparently prevents the decrease in the specific resistance of the medium, and allows an appropriate voltage to be applied to the medium. On this account, it is possible to prevent the decrease in luminance and the unevenness in luminance.

The present invention ensures (i) realization of the intrinsic high-speed response property of the display element employing the medium, the magnitude of whose optical anisotropy varies according to voltage application, and (ii) prevention of the decrease in the transmittance, and of the unevenness in luminance. This surely improves display response speed of a display apparatus including the display element, for example, display apparatus provided in televisions, word processors, personal computers, video cameras, digital cameras, or information terminals such as mobile phones. On this account, in the display apparatus, it is possible to prevent the decrease in the transmittance and the unevenness in luminance. Further, because the display element of the present invention has the high-speed response property as described above, the display element is suitable for performing a large screen display operation and a moving image display operation.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a diagram for explaining arrangements of electrodes in a display element of the present invention.

FIG. 2(a) is a cross sectional view of a display element of the present invention when no voltage is applied.

FIG. 2(b) is a cross sectional view of the display element of the present invention when a voltage is applied.

FIG. 3 is an explanatory diagram illustrating respective arrangements of comb-shaped electrodes and polarizers.

FIG. 4(a) is a cross sectional view of a conventional liquid crystal display element when no voltage is applied. FIG. 4(b) is a cross sectional view of the conventional liquid crystal display element when a voltage is applied. FIG. 4(c) is a graph illustrating a voltage-transmittance curve.

FIG. 5(a) is a cross sectional view of a conventional liquid crystal display element when no voltage is applied. FIG. 5(b) is a cross sectional view of the conventional liquid crystal display element when a voltage is applied.

FIG. 6 is an explanatory view illustrating difference between a display principle of the present display element and that of the conventional display element.

FIG. 7 is a block diagram illustrating structures of a display apparatus using the display element according to one embodiment of the present invention.

FIG. 8 is a circuit diagram illustrating an equivalent circuit in the display element in the present invention.

FIG. 9 is a cross sectional diagram taken along line A-A′ of the display element illustrated in FIG. 1.

FIG. 10 is a circuit diagram illustrating an equivalent circuit in a conventional display element.

FIG. 11 is a diagram for explaining arrangements of electrodes of a display element of a comparative example.

FIG. 12 is a diagram for explaining arrangements of electrodes of a display element of another embodiment of the present invention.

FIG. 13 is a cross sectional diagram taken along line B-B′ of the display element shown in FIG. 11.

FIG. 14 is a diagram for explaining arrangements of electrodes of a display element of still another embodiment of the present invention.

FIG. 15 is a cross sectional diagram taken along line C-C′ of the display element shown in FIG. 14.

FIG. 16 is a schematic view illustrating a structure of a liquid crystal micro emulsion.

FIG. 17 is a schematic view illustrating a structure of a liquid crystal micro emulsion.

FIG. 18 is classification diagram of a lyotropic liquid crystal phase.

FIG. 19 is a diagram illustrating an example of arrangement of electrodes applicable to the display element of the present invention.

FIG. 20 is a diagram illustrating an example of arrangement of electrodes applicable to the display element of the present invention.

### DESCRIPTION OF THE EMBODIMENTS

[First Embodiment]

The following description explains an embodiment of the present invention with reference to the figures.

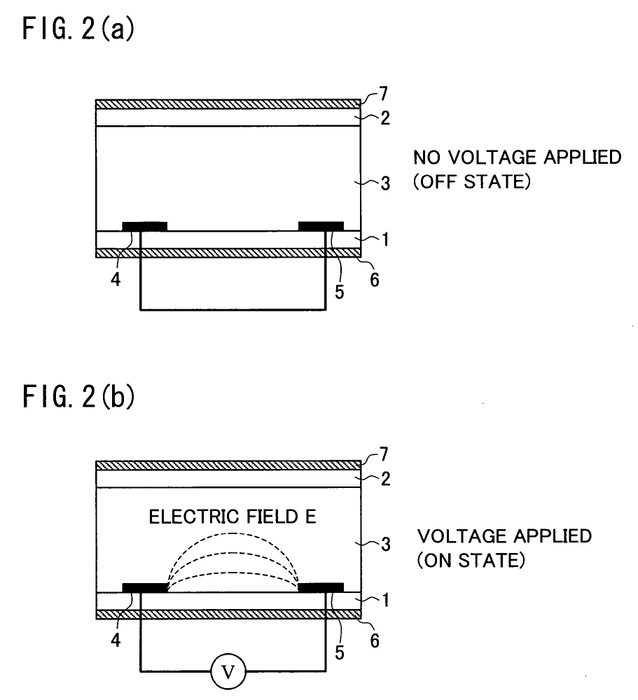

FIGS. 2(a) and 2(b) are cross-sectional views each of which schematically illustrates an arrangement of a display element (present display element) of the present embodiment.

The present display element is structured such that a dielectric material layer 3 (optical modulation layer) is sandwiched between two substrates (substrates 1 and 2) which are provided face to face. Moreover, comb-shaped electrodes (first and second electrodes) 4 and 5 are provided face to face on the substrate 1 so as to be positioned in a surface which faces the substrate 2. The comb-shaped electrodes are provided as electric field application means in order to apply an electric field to the dielectric material layer 3. Furthermore, polarizers 6 and 7 are respectively provided on rear surfaces with respect to the opposing surfaces of the substrates 1 and 2.

Note that, FIG. 2(a) illustrates a state in which no voltage (electric field) is applied between the comb-shaped electrodes 4 and 5 (no voltage (electric field) application state (OFF state)). FIG. 2(b) illustrates a state in which a voltage (electric field) is applied between the comb-shaped electrodes 4 and 5 (voltage (electric field) application state (ON state)).

The substrates 1 and 2 are glass substrates. Note that, materials of the substrates 1 and 2 are not limited to this as long as at least one of the substrates 1 and 2 is transparent. Note that, an interval between the substrates in the present display element, that is, a thickness of the dielectric material layer 3 is 10 μm. However, the interval between the substrates is not limited to this, but may be determined arbitrarily.

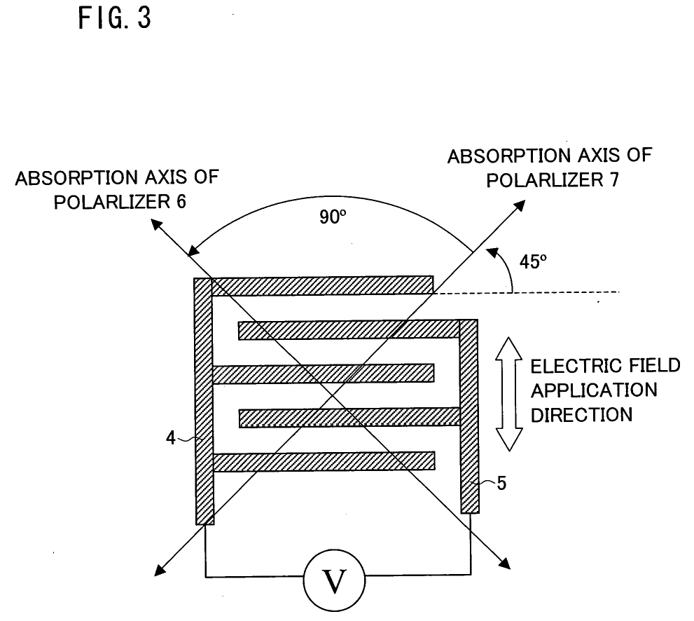

FIG. 3 is an explanatory view illustrating positions of the comb-shaped electrodes 4 and 5 and directions of absorption axes of the polarizers 6 and 7. As illustrated in FIG. 3, the comb-shaped electrodes, which are formed like comb-teeth, are provided face to face. Note that, each of the comb-shaped electrodes 4 and 5 has a line width of 5 μm, and a distance between the electrodes (electrode interval) is 5 μm. However, the present invention is not limited to this. For example, it is possible to set these values arbitrarily according to a gap between the substrate 1 and the substrate 2. Moreover, as materials of the comb-shaped electrodes 4 and 5, it is possible to use various materials which are conventionally well-known, such as transparent electrode materials (ITO (indium tin oxide), etc), metal electrode materials (aluminum, etc), or the like.

Moreover, as illustrated in FIG. 3, the polarizers 6 and 7 respectively provided on the substrates 1 and 2 are arranged such that respective absorption axes are orthogonal with each other, and absorption axes of the polarizers are at an angle of about 45° with respect to directions to which comb-teeth portions of the comb-shaped electrodes 4 and 5 extend. On this account, the absorption axis of each of the polarizers is at an angle of about 45° with respect to an electric field application direction.

The dielectric material layer 3 is made of BABH8 described in Non-patent Documents 5 and 6. BABH8 is represented by the following structural formula (1). Note that the composite shows a nematic phase at a temperature less than 33.3° C., and shows an isotropic phase at a temperature of 33.3° C. or greater.

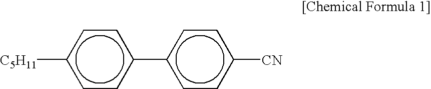

The liquid crystal display element 20 is kept at a temperature which is just above the nematic phase/isotropic phase transition temperature (a little higher than the phase transition temperature; for example +0.1K) by an outer heating device. When an electric field is applied to the liquid crystal display element 20, the transmissivity can be changed.

Note that, if necessary, alignment films subjected to a rubbing treatment may be respectively formed on the opposing surfaces of the substrates 1 and 2. In this case, the alignment film formed on the substrate 1 may be formed so as to cover the comb-shaped electrodes 4 and 5.

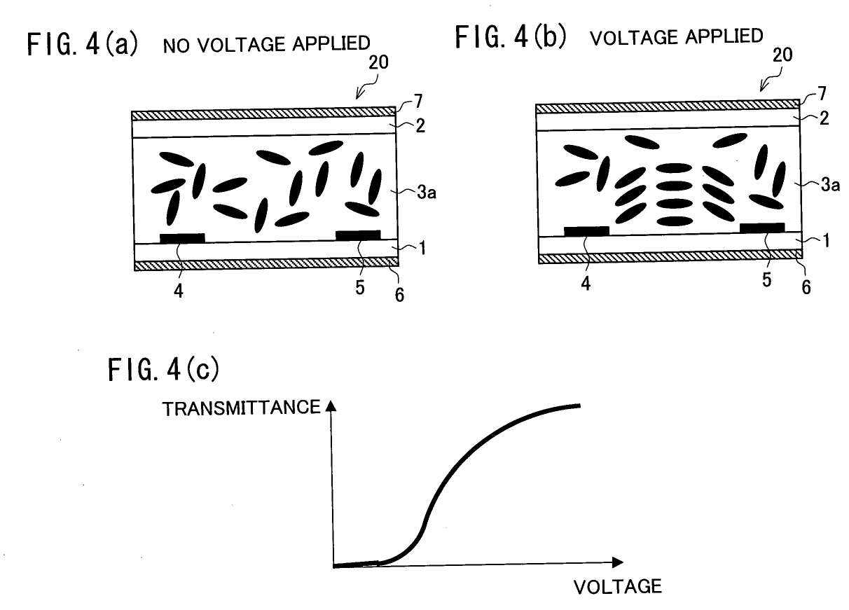

The following description explains a display principle of the present display element with reference to FIG. 4(a) and FIG. 4(b). FIG. 4(a) and FIG. 4(b) are explanatory diagrams, each of which schematically illustrates a liquid crystal display element 20 having the aforementioned structure, as one example of the liquid crystal display element of the present invention.

Note that, FIG. 4(a) is an explanatory view illustrating an alignment state of the liquid crystal molecules in the liquid crystal display element 20 at a temperature which is just above the nematic phase/isotropic phase transition temperature under such condition that no electric field is applied to the liquid crystal display element 20. FIG. 4(b) is an explanatory view illustrating an alignment state of the liquid crystal molecules in the liquid crystal display element 20 at a temperature which is just above the nematic phase/isotropic phase transition temperature under such condition that an electric field is applied to the liquid crystal display element 20.

As shown in FIG. 4(a), under no applied voltage, a dielectric material layer 3a made from the foregoing compound is in an isotropic phase, and is therefore optically isotropic. Therefore, the liquid crystal display element 20 performs black display in this state. In contrast, as shown in FIG. 4(b), when a voltage is applied, the molecules of the compound in an applied electric field are aligned in such a manner that their long axes are along the direction of electric field. This causes double refraction, enabling the transmittance of the liquid crystal display element to be modulated.

FIG. 4(c) is a voltage-transmittance curve as a function of an applied voltage to the liquid crystal display element 20 maintained at a temperature in the vicinity of the nematic phase/isotropic phase transition temperature. As shown in FIG. 4(c), the transmittance of the liquid crystal display element 20 varies according to an applied voltage.

Here, according to non-patent document 4 (“Handbook of Liquid Crystals”, Vol. 1, pp. 484-485, Wiley-VCH, 1998), double refraction caused by electric field application can be represented by the following formula:

Δn=λBE², where λ indicates the wavelength of light, B indicates the Kerr constant, and E indicates the strength of applied electric field.

Further, the Kerr constant B has the following relation:
B∝(T−Tni)⁻¹

Therefore, while it is possible to drive the liquid crystal display element 20 by application of a weak electric field when the liquid crystal display element 20 is at a temperature in the vicinity of the phase transition point (Tni), the electric field strength required for the driving dramatically increases as the temperature (T) rises. For this reason, although a voltage of approximately 100 V is sufficient for the modulation of transmittance while at a temperature slightly higher than the phase transition point, a greater voltage is required for the modulation of transmittance at temperatures sufficiently away from the phase transition temperature (i.e., temperatures far exceeding the phase transition temperature).

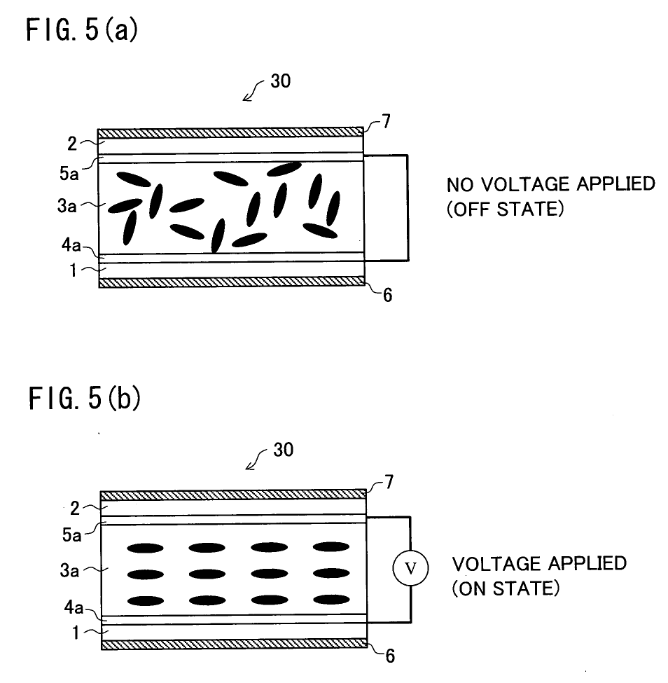

Note that the foregoing explained the liquid crystal display element 20 to which a voltage is applied parallel with the surfaces of the substrates. However, such precise temperature control is also required for other types of liquid crystal display elements, for example, as in a liquid crystal display element 30 (see FIG. 5(a) and FIG. 5(b)) to which a voltage is applied in a direction normal to the surfaces of the substrates.

Instead of the comb-shaped electrodes 4 and 5 of the liquid crystal display element 20, the liquid crystal display element 30 includes transparent electrodes 4a and 5a, which are respectively provided on the opposing surfaces of the substrates 1 and 2. Namely, the liquid crystal display element 30 is one example of a liquid crystal display element using the electro-optic effect, like the liquid crystal display element 20.

As shown in FIG. 5(a), the liquid crystal display element 30 is kept at a temperature which is just above the phase transition temperature of the medium injected and sealed in the dielectric material layer 3a. When no electric field is applied, the dielectric material layer 3a is in the isotropic phase as illustrated in FIG. 5(a). When an electric field is applied, the long-axis directions of the liquid crystal molecules are aligned in a direction perpendicular to an electric field as illustrated in FIG. 5(b).

Like the liquid crystal display element 20, the liquid crystal display element 30 thus arranged also requires a greater voltage for the modulation of transmittance at temperatures far exceeding the phase transition temperature. This prevents realization of high-speed response, and causes reduced transmittance and uneven luminance.

However, as in the liquid crystal display element 20 of the lateral electric field mode, display quality can be effectively improved by providing an auxiliary capacitor.

The following further explains differences in display principle between the present display element and conventional liquid crystal display elements.

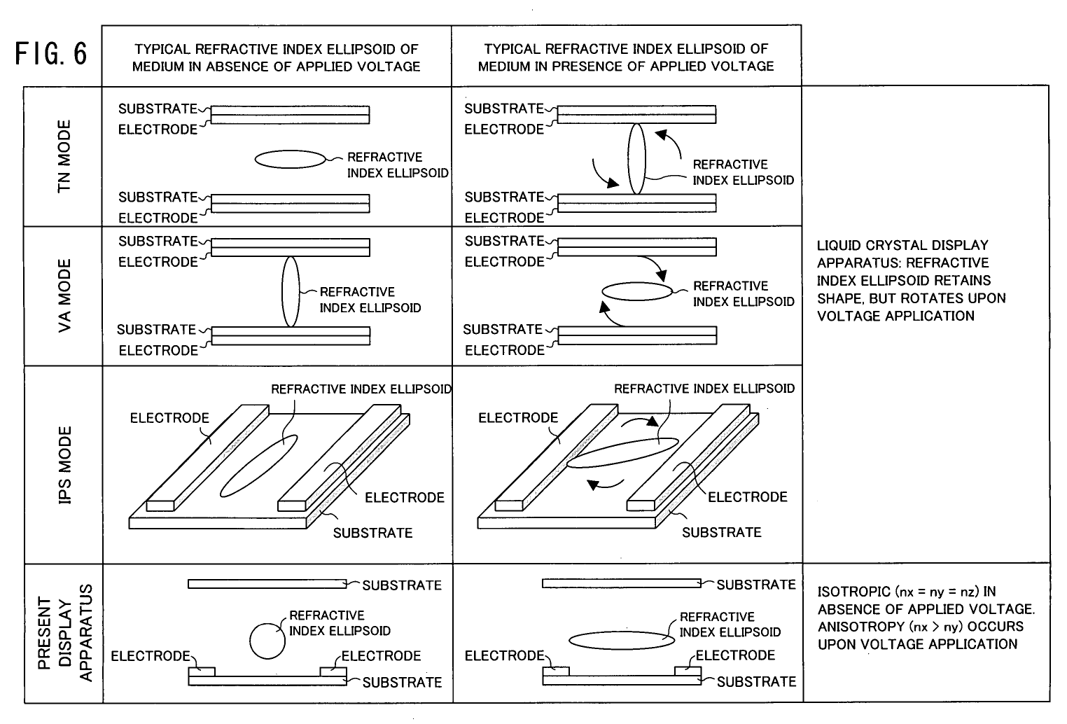

FIG. 6 is an explanatory diagram illustrating the differences of the display principle between the present display element and the conventional display elements, and FIG. 4 schematically illustrates the shape of the refractive index ellipsoid and the direction of the refractive index ellipsoid in case where an electric field is applied and in case where no electric field is applied. Note that, FIG. 6 shows the display principles of the conventional liquid crystal display elements such as a TN mode liquid crystal display element, a VA (Vertical Alignment) mode liquid crystal display element, and an IPS (In Plane Switching) mode liquid crystal display element.

As illustrated in FIG. 6, the TN mode liquid crystal display element is structured such that a liquid crystal layer is sandwiched between two substrates which are provided face to face, and transparent electrodes (electrodes) are respectively provided on the substrates. When no electric field is applied, liquid crystal molecules of the liquid crystal layer are aligned such that the liquid crystal molecules are helically twisted in a long-axis direction. When an electric field is applied, the liquid crystal molecules are aligned such that the long-axis direction of each of the liquid crystal molecules is along an electric field direction. As illustrated in FIG. 6, an average refractive index ellipsoid in this case is such that its long-axis direction is parallel to the substrate surface when no electric field is applied, and its long-axis direction turns to the normal direction of the substrate surface when an electric field is applied. That is, the shape of the refractive index ellipsoid is ellipse when no electric field is applied and when an electric field is applied. However, when an electric field is applied, the long-axis direction of the refractive index ellipsoid changes (a direction of the refractive index ellipsoid). That is, the refractive index ellipsoid rotates. Note that, the shape of the refractive index ellipsoid when no electric field is applied is substantially the same as the shape of the refractive index ellipsoid when an electric field is applied.

Like the TN mode liquid crystal display element, the VA mode liquid crystal display element is structured such that a liquid crystal layer is sandwiched between two substrates which are provided face to face, and transparent electrodes (electrodes) are respectively provided on the substrates. However, in the VA mode liquid crystal display element, when no electric field is applied, liquid crystal molecules of the liquid crystal layer are aligned such that the long-axis direction of each of the liquid crystal molecules turns substantially perpendicular to the substrate surface. When an electric field is applied, the liquid crystal molecules are aligned such that the long-axis direction of each of the liquid crystal molecules turns perpendicular to an electric field. As illustrated in FIG. 6, an average refractive index ellipsoid in this case is aligned such that the long-axis direction turns to the normal direction of the substrate surface when no electric field is applied, and the long-axis direction is parallel to the substrate surface when an electric field is applied. That is, the shape of the refractive index ellipsoid is ellipse when no electric field is applied and when an electric field is applied. However, the long-axis direction of the refractive index ellipsoid changes (the refractive index ellipsoid rotates). Note that, the shape of the refractive index ellipsoid when no electric field is applied is substantially the same as the shape of the refractive index ellipsoid when an electric field is applied.

Next, the IPS mode liquid crystal display element is structured such that a pair of electrodes are provided face to face on a substrate, and a liquid crystal layer is formed in a region between the electrodes. When an electric field is applied, alignment directions of liquid crystal molecules of the liquid crystal layer are changed, so that it is possible to realize different display states depending on whether or not an electric field is applied. Thus, also in the IPS mode liquid crystal display element, as illustrated in FIG. 6, the shape of the refractive index ellipsoid is ellipse when no electric field is applied and when an electric field is applied. However, the long-axis direction of the refractive index ellipsoid changes (the refractive index ellipsoid rotates). Note that, the shape of the refractive index ellipsoid when no electric field is applied is substantially the same as the shape of the refractive index ellipsoid when an electric field is applied.

Thus, according to the conventional liquid crystal display elements, the liquid crystal molecules are aligned in a certain direction when no electric field is applied. When an electric field is applied, alignment directions of the liquid crystal display molecules are changed so as to carry out the display (modulation of transmissivity). That is, the direction of the refractive index ellipsoid is rotated (changed) by applying an electric field, so that the display is carried out. That is, according to the conventional liquid crystal display elements, an orientational order parameter is constant, and the display is carried out by changing the alignment directions.

Meanwhile, as illustrated in FIG. 6, according to the present display element, the refractive index ellipsoid when no electric field is applied is globular. That is, the refractive index ellipsoid is optically isotropic (an orientational order parameter is 0) when no voltage is applied. When a voltage is applied, the refractive index ellipsoid becomes optically anisotropic (an orientational order parameter >0). That is, according to the present display element, the shape of the refractive index ellipsoid is isotropic (nx=ny=nz) when no electric field is applied, and the shape of the refractive index ellipsoid is anisotropic (nx>ny) when an electric field is applied. Note that, nx is a refractive index with respect to a direction parallel to the substrate surface and parallel to a counter direction of the electrodes, and ny is a refractive index with respect to a direction parallel to the substrate surface and perpendicular to a counter direction of the electrodes, and nz is a refractive index with respect to a direction perpendicular to the substrate surface.

Thus, according to the present display element, the alignment directions of the molecules are fixed (voltage application direction does not vary), and the display is carried out by modulating the orientational order parameter which influences visible light. That is, in the present display element, the optical anisotropy (or, the orientational order which influences visible light) of the medium itself changes. Therefore, the present display element is totally different from the conventional display elements in terms of the display principle.

In other words, in the present display element, the magnitude of the optical anisotropy of the medium varies according to that shape change of the refractive index ellipsoid which is caused by voltage application. Therefore, a longitudinal axis of the refractive index ellipsoid of the present display element is parallel or perpendicular to the electric field direction.

Meanwhile, because in each of the conventional liquid crystal elements, the long-axis of the refractive index ellipsoid is rotated so as to carry out a display, a longitudinal axis of the refractive index ellipsoid is not limited to the parallel or perpendicular direction with respect to the electric field direction.

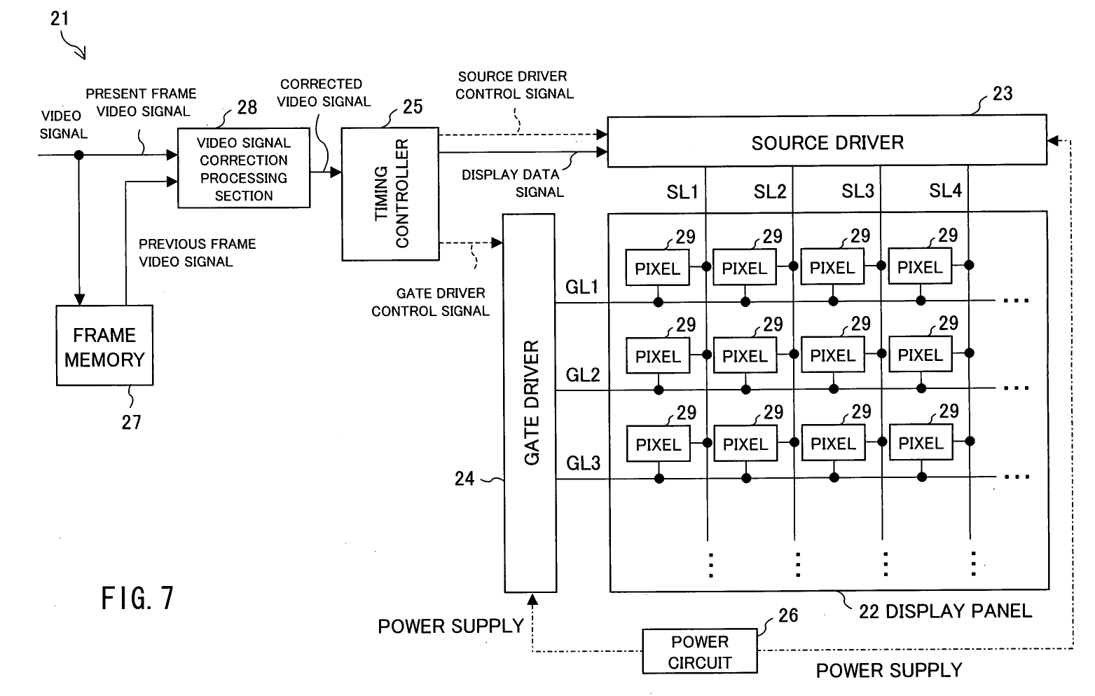

The following explains structure of a display apparatus using the aforementioned display element. As shown in FIG. 7, a display apparatus 21 of the present embodiment includes: (i) a display panel 22 in which pixels each having the display element are provided in a matrix manner; (ii) a source driver 23 for driving data signal lines SL1 through SLn of the display panel 22; (iii) a gate driver 24 for driving scan signal lines GL1 through GLm; (iv) a controller 25; and (v) a power circuit 26 for supplying, to the source driver 23 and the gate driver 24, voltages for displaying an image on the display panel 22.

The display apparatus 21 further includes a frame memory 27 and a video signal correcting section 28. The frame memory 27 stores an input video signal from an external apparatus frame by frame. The video signal correcting section 28 corrects a current frame video signal (current frame video signal; current video signal), which is supplied from an external device, based on this video signal and a video signal of the immediately preceding frame (previous frame video signal; previous video signal), and outputs the corrected video signal to the controller 25. Note that the “frame” is the unit of transmission of the video signal sent from an external device. Note also that how the video signal correcting section 28 carries out the correction process will be described later.

The controller 25 outputs, to the source driver 23, (i) digitalized display data signals (for example, video signals of red (R), green (G), and blue (B)) and (ii) a source driver control signal for controlling an operation of the source driver 23. Further, the controller 25 sends, to the gate driver 24, a gate driver control signal for controlling an operation of the gate driver 24. Examples of the source driver control signal include a horizontal synchronization signal, a start pulse signal, and a clock signal for the source driver. Examples of the gate driver control signal include a vertical synchronization signal and a clock signal for the gate driver. Further, according to the corrected video signal supplied from the video signal correcting section 28, the controller 25 determines a display data signal to be sent to the source driver 23.

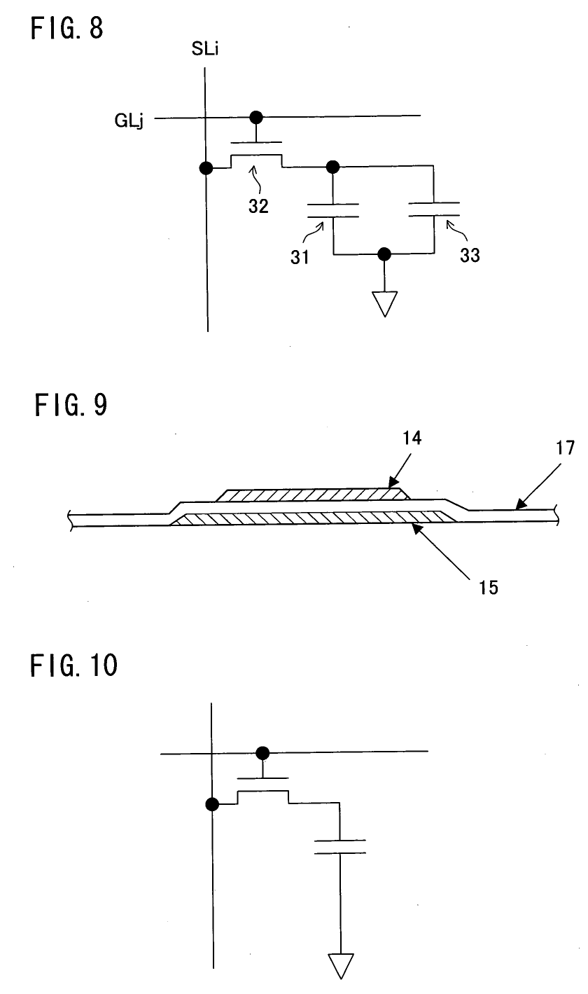

The display panel 22 includes: a plurality of the data signal lines SL1 through SLn; and a plurality of the scan signal lines GL1 through GLm which intersect with the data signal lines SL1 through SLn. At each intersection of the data signal lines and the scan signal lines, a pixel 29 is provided. The pixel 29 includes a display element 31 of a structure to be described later, and a switching element 32, as shown in FIG. 8.

The switching element 32 is realized by a TFT (thin film transistor) and is so arranged that its gate is connected to a scan signal line GLj, and that its drain is connected to a data signal line Sli. The source of the switching element 32 is connected to a capacitor 31 and an auxiliary capacitor 33, which are connected to each other in parallel in the display element. The other ends of the capacitor 31 and the auxiliary capacitor 33 of the display element are connected to a common electrode line common to all pixels.

In the pixel 29, when the scan signal line GLj is selected, the switching element 32 is switched ON, and a signal voltage determined according to the display data signal sent from the controller 5 is applied by the source driver 23 to the capacitor 31 and the auxiliary capacitor 33 of the display element via the data line SLi. After the select period of the scan signal line GLj, the display element 31 should ideally maintain the voltage while the switching element 32 is switched OFF.

The transmittance or reflectance of the display element 31 varies according to a signal voltage applied by the switching element 32. Therefore, a display state of each pixel 29 can be varied according to video data by selecting the scan signal line GLj and applying a signal voltage, corresponding to a display data signal for the pixel 29, from the source driver 23 to the data signal line SLi.

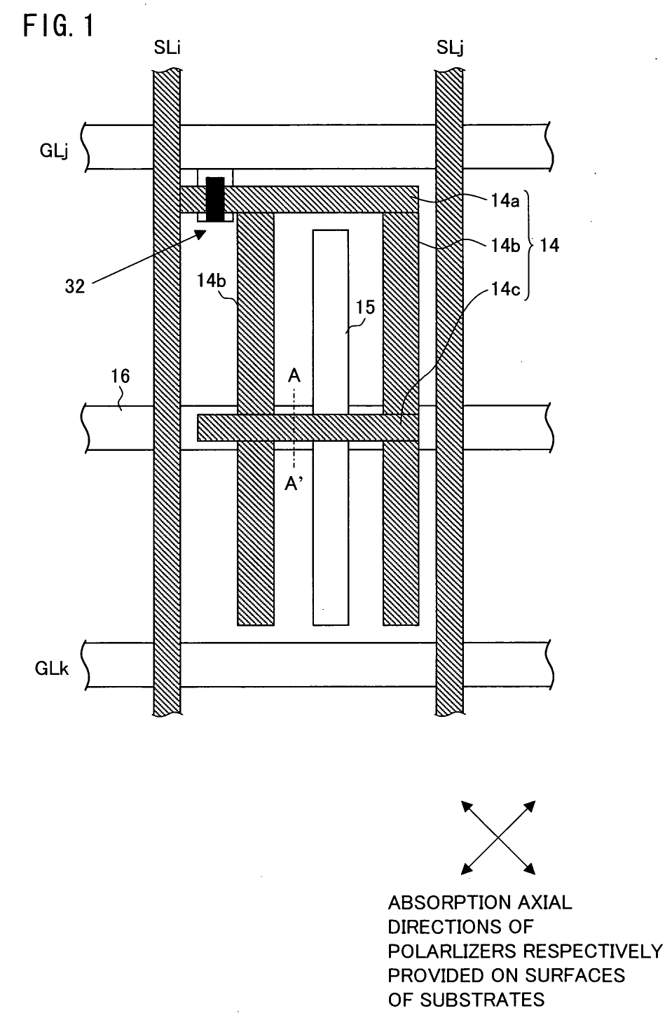

Next, the following explains a structure forming the auxiliary capacitor 33. In the present embodiment, the auxiliary capacitor 33 is formed by wiring lines and providing electrodes. FIG. 1 illustrates lines and electrodes in a pixel 29i that is formed by a combination of a data signal line SLi and a scan signal line GLi. The electrodes shown in FIG. 1 are another implementation of the comb-shaped electrodes 4 and 5 shown in FIG. 3.

In FIG. 1, a comb-like signal electrode (first electrode; one of the comb-shaped electrodes) 14 is so provided on the substrate 1 as to be connected to the source of the switching element 32. Note that the signal electrode 14 can be regarded as a portion of the pixel electrode. The signal electrode 14 includes: (i) a portion (first electrode) 14a that extends from the switching element 32 substantially parallel with the scan signal line GLm; (ii) two branch portions (first electrode) 14b branching off substantially parallel with the data signal line SLn; and (iii) an auxiliary capacitor portion (auxiliary electrode; second electrode) 14c that connects the branch portions 14b substantially perpendicular to the branch portions 14b. A counter electrode line (second electrode; the other comb-shaped electrode) 16 is provided between a scan signal line GLj and a scan signal line GLk of the next row, parallel to these lines. The counter electrode line 16 is connected to a counter electrode (second electrode) 15 that is so provided as to interact with the comb-like signal electrode 14. In other words, the counter electrode 15 is disposed between the branch portions 14b of the signal electrode 14, and extends substantially perpendicular from the counter electrode line 16. With this arrangement, it is possible to form an electric field between the branch portions 14b and the counter electrode 15. This allows the branch portions 14b and the counter electrode 15 to serve as the comb-shaped electrodes shown in FIG. 3.

Note that the counter electrode line 16 (or counter electrode 15) and the scan signal lines GL do not conduct to the overlying source signal lines SL (or the signal electrode 14) because they are separated from each other by an insulating film 17. The insulating film 17 is layered on a first layer including the counter electrode 15, the counter electrode line 16, and the scan signal lines GL. On the insulating film 17, a second layer including the signal electrode 14 and the scan signal lines SL is layered. It is preferable that the insulating film 17 and a gate insulating layer of the TFTs constitute the same layer.

Here, the auxiliary capacitor portion 14c of the signal electrode 14 is so provided as to be overlaid on the counter electrode line 16. Thus, in a portion of the display element where the auxiliary capacitor portion 14c is formed (cross section taken along the line A-A′), the signal electrode 14 partially overlaps with the counter electrode 15 as shown in FIG. 9. With this arrangement, an auxiliary capacitor is formed that is parallel to the capacitor of the display element, as shown in FIG. 8. With the auxiliary capacitor 33, the display element including the medium whose optical anisotropy varies according to an applied electric field can prevent uneven luminance, reduced transmittance, and afterimage in moving images.

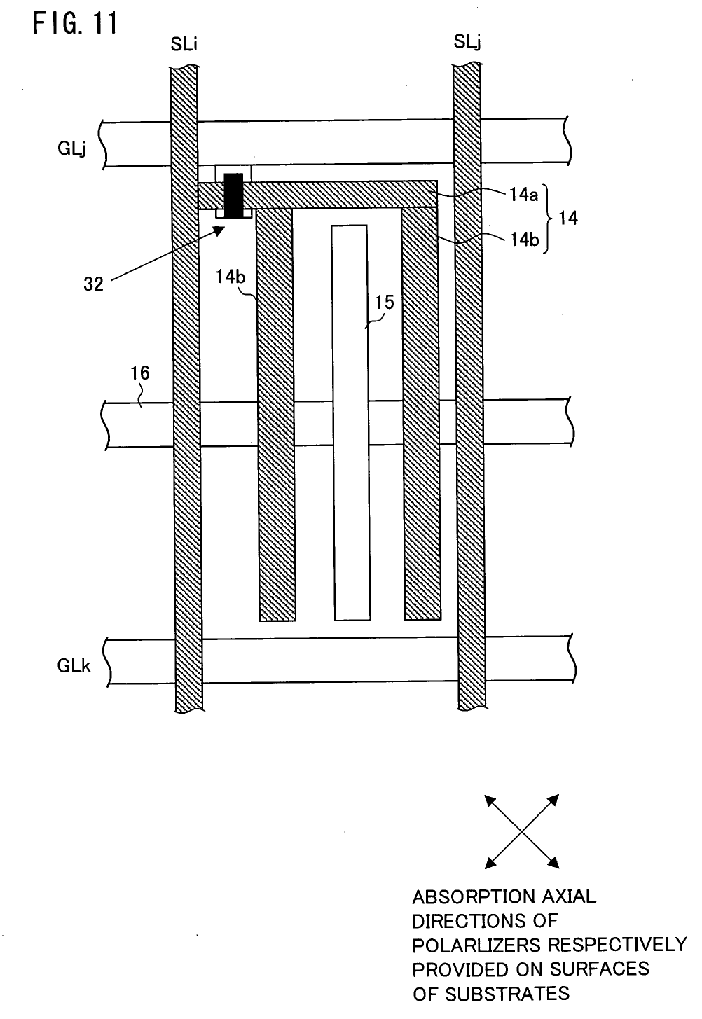

The reasons for this are described below in detail. In the case of using a display element having no auxiliary capacitor, as represented by an equivalent circuit shown in FIG. 10 (i.e., having no auxiliary capacitor portion 14c shown in FIG. 11), a display using such display elements formed in a matrix suffers from reduced transmittance, severe uneven luminance, and afterimage in moving images.

The reduced transmittance and uneven luminance arise from the property of the medium whose anisotropy varies according to an applied voltage. Specifically, because such a medium has large polarization, the medium is apt to draw impurity ions. Moreover, the display element adopting the display principle described so far requires a greater voltage than the conventional display elements. The increased voltage works against the quality of the medium, and it too causes increase in the impurity ion concentration of the medium. As the impurity ion concentration of the medium increases, the specific resistance of the medium decreases. Accordingly, the charge stored in the pixel capacitor via the switching element starts to reduce when the switching element 32 is switched OFF, with the result that the voltage in the pixel is reduced. This reduces luminance. Moreover, because the specific resistance is decreased unevenly in the display, the luminance becomes uneven in the display.

Further, the afterimage in moving images also arises from the property of the medium of the present display element. Specifically, in the present display element, as the voltage increase, the molecules of the medium align more orderly. This increases the capacitance. In other words, as the voltage increases, the capacitance of the display element of the present embodiment monotonously increases. This is problematic because the applied voltage cannot immediately reach the target voltage. In other words, the applied voltage is insufficient.

For example, the display element is caused to respond from (i) a state of: a voltage of 0.0 V and capacitance of 0.325 nF, to (ii) a state of: a voltage of 40.0 V and capacitance of 0.590 nF. Note that, hereinafter, 0.0 V is indicated by V0, 0.325 nF is indicated by C0, 40.0 V is indicated by V1, and 0.590 nF is indicated by C1.

That is, at V0, when V1 is a target voltage of the signal voltage applied to the display element, the charge Q01 stored in the display element in response to V1 is:
Q01=C0·V1(=13.0(nC))

However, the amount of charge Q1 which should be stored in the display element at V1 and C1 is:
Q1=C1·V1(=23.6(nC))

Here, because C0<C1, Q01<Q1. It is clear from this that the amount of stored charge will be insufficient. Specifically, because the capacitance of the display element increases while the voltage is applied to the display element, the voltage of the display element does not reach the target voltage.

This problem can be solved by keeping the capacitance unchanged as much as possible when the voltage increases. In other words, the problem is solved by setting Con/Coff close to 1, where Coff indicates the capacitance of the display element when the display element is OFF (black), and Con indicates the capacitance thereof when the display element is ON (white).

The display element including the auxiliary capacitor 33 can reduce the rate of change of the capacitance of the display element. That is, the auxiliary capacitor 33 is formed between the electrodes, and no medium but only the insulating layer is provided therebetween. On this account, even when a voltage is applied, capacitance (auxiliary capacitance) Cs of the auxiliary capacitor does not vary. Moreover, because the auxiliary capacitor 33 having an unvarying capacitance is formed parallel with the pixel capacitor in the equivalent circuit, the rate of change of the capacitance of the whole display element becomes relatively low. Specifically, when the auxiliary capacitance is Cs, the rate of change of the capacitance of the whole display element is given by
(Con+Cs)/(Coff+Cs)),
ensuring that
(Con+Cs)/(Coff+Cs)<Con/Coff.
In an extreme case, by taking the auxiliary capacitance Cs as infinity, the left-hand side of the inequality becomes 1. In other words, the capacitance of the whole display element does not change.

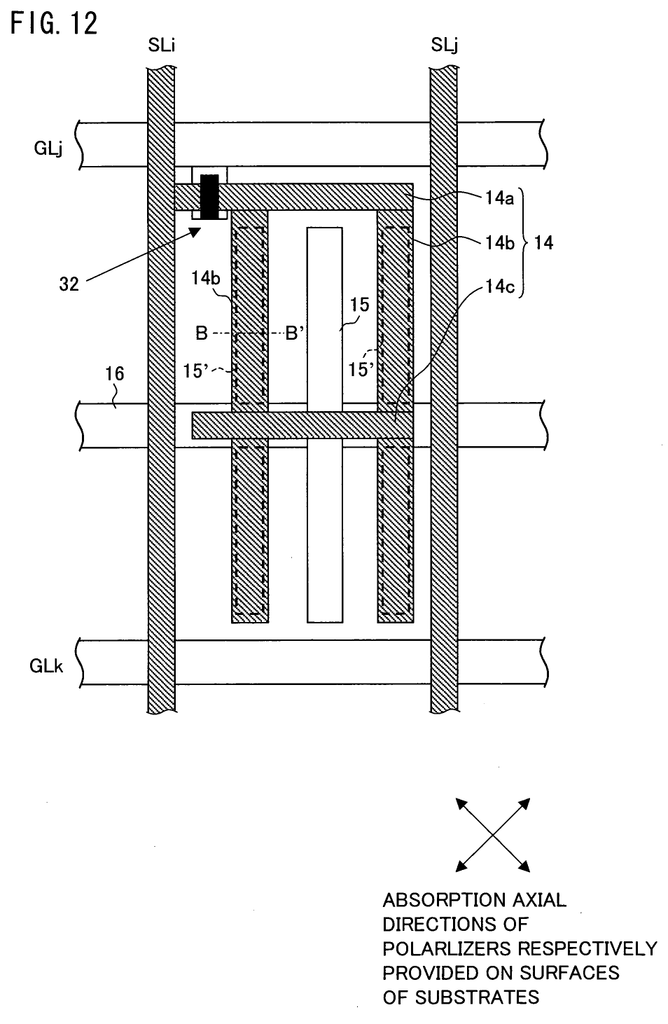

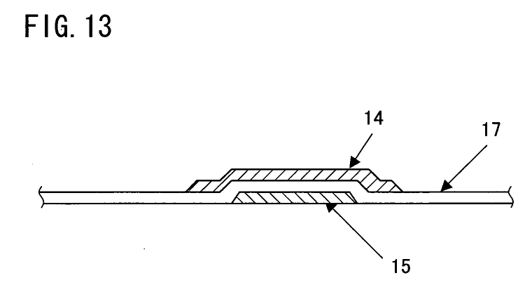

Note that the auxiliary capacitor is not limited to the arrangement of the electrodes shown in FIG. 1. For example, in the case of constructing a display in which pixels are provided in a matrix manner, the arrangement shown in FIG. 12 may be effectively used. Specifically, a second auxiliary capacitor may be formed by extending auxiliary capacitor portions 15′ of the counter electrode 15 from the counter electrode line 16. The auxiliary capacitor portions 15′ extend below the branch portions 14b (portions parallel to the data signal lines) of the signal electrode, as indicated by dotted lines in FIG. 12. With this arrangement, the signal electrode 14 is overlaid on the auxiliary capacitor portions 15′ with the insulating film 17 therebetween, as shown in FIG. 13. FIG. 13 is a cross sectional view taken along the line B-B′ in FIG. 12.

Further, by providing another line for the auxiliary capacitor electrode, another auxiliary capacitor electrode may be provided independently from the electrode for applying an electric field to the medium.

As described above, it is preferable that the electrode for the auxiliary capacitor be so provided as to overlie the already-provided electrode for applying an electric field to the medium. This allows a formation of a larger auxiliary capacitor while preventing a decrease in open area ratio of the display element. Note that the term “open area ratio” refers to a value determined by: A/B, where A indicates that area of the display element which allows light to pass through, and B indicates a total area of the display element. As the open area ratio decreases, the display screen becomes darker. Generally, an auxiliary capacitor are formed, independently from electrodes for applying a voltage to a medium, by providing: (i) a layer (light-shielding material) for forming a counter electrode and scan signal lines; (ii) a layer for forming a gate insulating film; and (iii) a layer (light-shielding material) for forming data signal lines. Therefore, the formation of the new electrode increases the area allowing no light to pass through, and decreases the open area ratio. On the contrary, in the present embodiment, the electrode for the auxiliary capacitor is so provided as to overlie the electrode for applying a voltage to the medium, and is provided in one piece with the other electrode for applying a voltage to the medium. This reduces the area allowing no light to pass through, and prevents the decrease in the open area ratio. Further, the area allowing no light to pass through is minimized and the open area ratio is maximized by forming the auxiliary capacitor within a region that corresponds to the electrodes for applying an electric field to the medium.

In the case of forming the auxiliary capacitor by overlying (i) the electrode for forming the auxiliary capacitor on (ii) the electrode for applying an electric field to the medium, the signal electrode is so provided as to cover the counter electrode as shown in the cross sectional view of FIG. 13. By thus shielding the counter electrode with the signal electrode. it possible to prevent the auxiliary capacitor portion of the counter electrode from causing an adverse effect on the display.

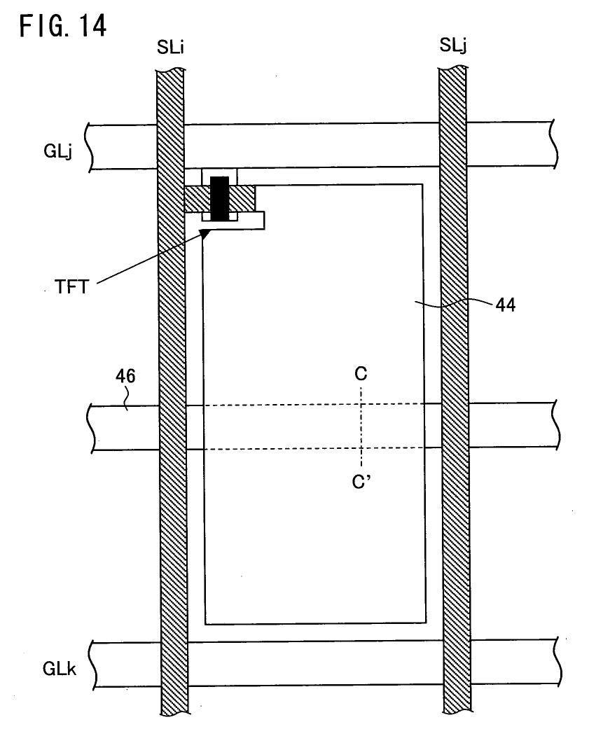

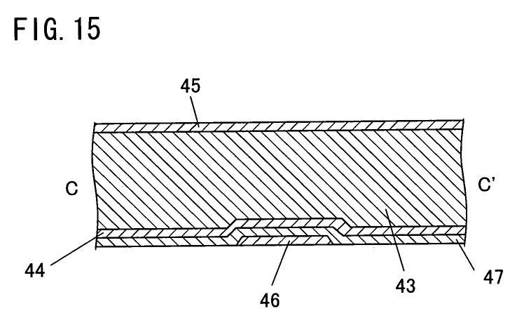

In some display element, the auxiliary capacitor can be formed merely by providing an auxiliary capacitor electrode line, instead of providing the electrodes. In such a display element as the liquid crystal display element 30 (see FIG. 5) in which a voltage is applied in the normal direction to the surfaces of the substrates, a counter electrode 45 and a pixel electrode (first electrode) 44 are provided on different surfaces with a dielectric material layer 43 therebetween as shown in FIG. 15. Therefore, the pixel electrode 44 thus provided has a comparatively large area. Specifically, the display element is so arranged that the pixel electrode 44, which is a transparent electrode and is typically made of ITO, is provided in an entire pixel region sectioned by a signal line SL and a scan line GL as shown in FIG. 14. In such a display element, the auxiliary capacitor can be formed by providing an auxiliary capacitor electrode line (auxiliary electrode) 46, having an arbitrary shape, as shown in FIG. 14 or FIG. 15. The auxiliary capacitor is so provided that it faces a portion of that side of the dielectric material layer 43 which is opposite to a side thereof with which the pixel electrode 44 faces, as shown in FIG. 14 or FIG. 15. FIG. 15 is a cross sectional view taken along line C-C′ in FIG. 14. With this arrangement, the auxiliary capacitor can be formed between the portion of the pixel electrode 44 and the auxiliary capacitor electrode line 46. Note that the auxiliary capacitor electrode line 46 has the same potential as the counter electrode 45, and can be therefore substantially considered as a counter electrode.

It is preferable that the auxiliary capacitor electrode line 46 be provided on the layer on which the scan signal lines GL are formed. With this arrangement, no additional manufacturing process is required for the formation of the auxiliary capacitor electrode line 46. Further, if the auxiliary capacitor electrode 46 is provided parallel to and between the scan lines as shown in FIG. 14, it becomes easy to manufacture the auxiliary capacitor electrode 46.

Note that, because the auxiliary capacitor electrode line 46 needs to be insulated from the pixel electrode 44, it is preferable that the auxiliary capacitor electrode 46 be so provided as to face the pixel electrode 44 with an insulating film 47 therebetween. Further, it is preferable that the auxiliary capacitor electrode line 46 be connected, outside the display region, to the counter electrode 45 (typically made of ITO) which is provided on the counter substrate, and be maintained at the same electric potential as is the counter electrode 45.

Next, actual display quality was observed using the display element having the auxiliary capacitor of the structure shown in FIG. 1.

The experiment was carried out using a single-pixel evaluation cell in which a FET was formed as the switching element, and in which the electrodes were arranged as shown in FIG. 1 to provide the auxiliary capacitor in parallel. The display quality was observed under auxiliary capacitance values of 0, 0.1, 0.4, 0.5, 1.0, 2.0, and 5.0, and with a pixel capacitance of 1 under no applied voltage. Note that the auxiliary capacitance of 0 was the condition that no auxiliary capacitor was formed, and was a comparative example of the present invention. The capacitance of the auxiliary capacitor was adjusted by using a commercially available capacitor.

Display quality was evaluated by examining unevenness in luminance and response characteristic as described below. Table 1 shows the result of evaluation.

TABLE 1

| Auxiliary capacitor | Change in luminance | Response property |
|---|---|---|
| 0 | X | X |
| (no auxiliary | | |
| capacitor) | | |
| 0.1 | X | X |
| 0.4 | Δ | X |
| 0.5 | Δ | X |
| 1 | ◯ | Δ |
| 2 | ◯ | ◯ |
| 5 | ◯ | ◯ |

Unevenness in Luminance: For each condition, a voltage was applied to five evaluation cells, and luminance was measured by using a luminance meter (trade name BM-5 provided by the TOPC0N corporation). Table 1 shows the result of the evaluation of variation in luminance among the five evaluation cells. In table 1, indicated by ∘ is “good,” indicated by Δ is “improved,” and indicated by x is “bad.” Specifically, unevenness in luminance was evaluated as Δ when variations of luminance among the five evaluation cells were in a range of ±50%, in other words, when the measured value of each evaluation cell was 0.5 times to 1.5 times the average value of the five evaluation values. Unevenness in luminance was evaluated as ∘ when variations of luminance among the five evaluation cells were in a range of ±10%, in other words, when the measured value of each evaluation cell was 0.9 times to 1.1 times the average value of the five evaluation values.

Response characteristic: A response waveform of transmittance of the dielectric material layer in response to an applied voltage (OFF state to ON state) was measured. Table 1 shows the result of evaluation in which the response characteristic was denoted by ∘ “good”, Δ “improved”, and x “bad” based on the time required to complete response (obtain a predetermined transmittance). Specifically, the response characteristic was evaluated as Δ when response was completed in a scan of two frames. Moreover, the response characteristic was evaluated as ∘ when response was completed in a scan of one frame.

According to Table 1, unevenness in luminance is improved when the auxiliary capacitor has a capacitance of 0.4 or greater, and is prevented and good display quality can be obtained when the auxiliary capacitance is 1 or greater, i.e., when the auxiliary capacitance value is equal to or greater than the pixel capacitance value. Also, the response characteristic is improved when the auxiliary capacitance is 1 or greater, and is good when the auxiliary capacitance is 2 or greater, i.e., when the auxiliary capacitance is two times or greater than the pixel capacitance. That is, afterimage in moving images is prevented.

Therefore, in order to obtain a display element having a good response characteristic, it is preferable that the auxiliary capacitor have a capacitance equal to or greater than the pixel capacitance. Further, it is more preferable that the auxiliary capacitor have a capacitance two times or greater than the pixel capacitance.

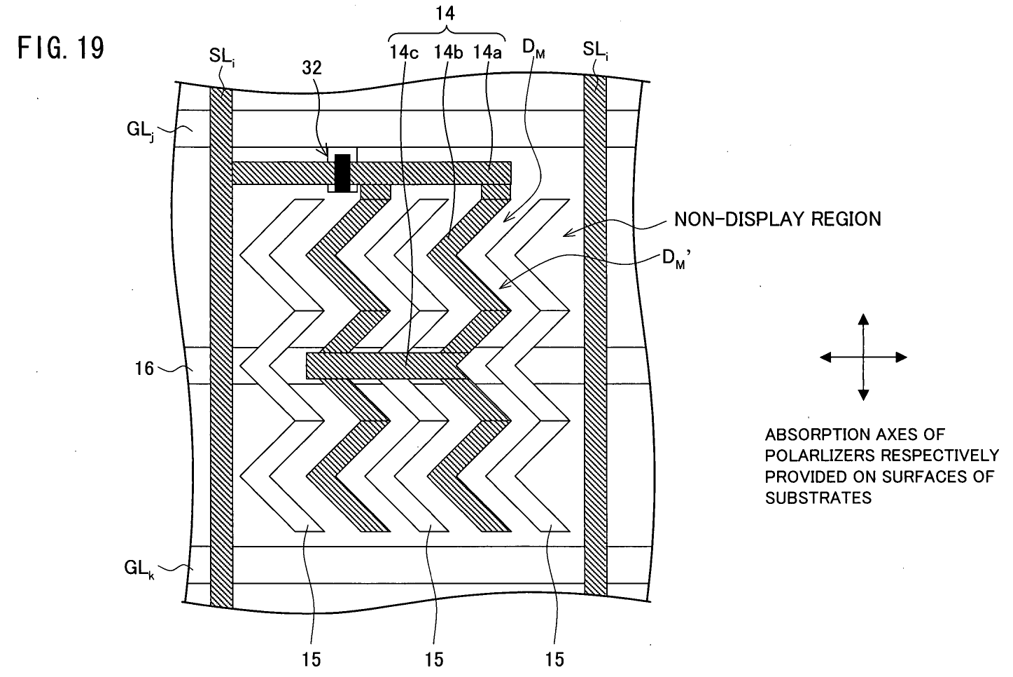

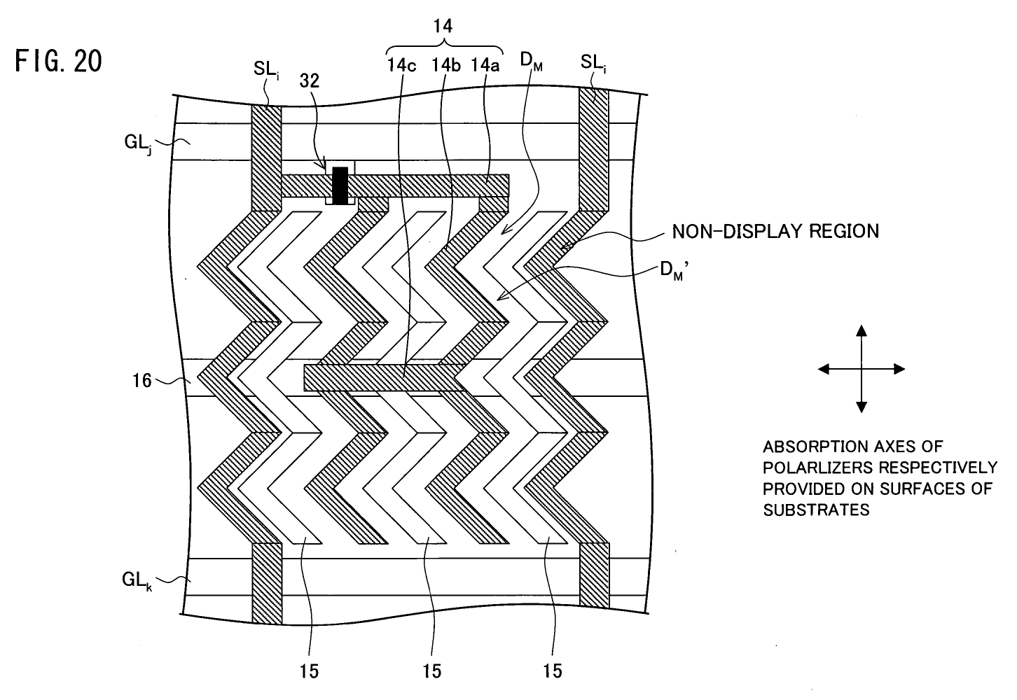

Note that the arrangement of the electrodes applicable to the display element according to the present invention is not limited to the arrangement shown in FIG. 1. The following explains an arrangement of the electrodes applicable to the display element with reference to FIG. 19 and FIG. 20.

As shown in FIG. 19, the display element of the present invention may be so arranged that the signal electrode 14 and the counter electrode 15 each bending in a zigzag manner at a bending angle of 90° is provided to form at least two domains D_{M} and D_{M}′ in which electric fields making 90° with each other are respectively applied by the signal electrode 14 and the counter electrode 15.

Note that the display element adopting the electrodes arranged as shown in FIG. 19 also includes the polarizer 6 and 7 provided on respective outer sides of the substrates 1 and 2. The polarizers 6 and 7 are so provided that their absorption axes are orthogonal to each other. In other words, they are so provided that the absorption axis direction of the polarizer 6 is orthogonal to the absorption axis direction of the polarizer 7. Further, each absorption axis of the polarizer 6 and 7 forms an angle of 45° with respect to the direction of electric field application by the signal electrode 14 and the counter electrode 15.

Note that, in the electrode structure shown in FIG. 19, there is a large non-display region between the data signal line SLi and the counter electrode 15. The non-display region was dramatically reduced by providing the data signal line SLi having a shape “parallel” to the zigzag shape of the counter electrode 15 as shown in FIG. 20, instead of a straight line-shaped data signal line SLi.

Note that, in the present display element, the compound represented by Chemical formula 1 is used as the medium injected and sealed in the dielectric material layer 3. However, the present invention is not limited to this. Any medium may be used as the medium injected and sealed in the dielectric material layer 3 as long as the medium is not liquid in view of a physical property and the alignment order magnitude changes when an electric field is applied to the medium, that is, the magnitude of the optical anisotropy changes by applying an electric field. Specifically, the material may be a material showing the Kerr effect or the Pockels effect, and may be liquid, gas, or solid.

For example, it is possible to use a medium which is optically isotropic when no voltage is applied and is optically anisotropic when a voltage is applied. That is, it is possible to use a medium which (i) has an orientational order (orderly structure) smaller than the optical wavelength when no electric field is applied, (ii) is transparent in a optical wavelength region, and (iii) changes its orientational order and becomes optically anisotropic when an electric field is applied.

Alternatively, it is possible to use the medium which (i) is optically anisotropic when no electric field is applied, and (ii) loses the optical anisotropy by the electric field application, so that the orderly structure becomes smaller than the optical wavelength, thereby expressing the optical anisotropy.

Therefore, for example, it is possible to use the medium which is made of molecules in the cubic phase, or the medium having an orderly structure unlike the cubic phase. Moreover, for example, it is possible to use the medium which is made of copolymer, amphiphilic molecule, dendrimer molecule, liquid crystal, etc.

Further, as described in Non-patent document 7 (Appl. Phys. Lett., Vol. 69, Jun. 10, 1996, p.1044.), by adding a gelatinizer (see Non-patent document 8: Adv. Func. Mater., Vol. 13, No.4, April 2003, pp.313-317.) to the medium, a display element having a higher speed response property and a higher contrast property may be realized. Further, as described in Non-patent document 9 (Nature Materials, Vol. 1, September, 2002, p.64.), by immobilizing polymers of the medium, the medium may stably exhibit a blue phase in a wide temperature range.

It is preferable that the medium A contain a liquid crystal material. Note that the liquid crystal material may be (i) a liquid crystal material which is made of a single material showing liquid crystallinity, (ii) a liquid crystal material in which a plurality of materials are mixed so as to show liquid crystallinity, (iii) a liquid crystal material in which other non-liquid crystal material is mixed in the plurality of materials.

For example, it is possible to use, as the liquid crystal material that can be contained in the medium A, a liquid crystal material described in Patent Document 1. Further, it is also possible to use a liquid crystal material prepared by adding a solvent to the liquid crystal material. Furthermore, it is also possible to use a liquid crystal material partitioned into small sections as described in Patent Document 2 (Japanese Laid-Open Patent Application Tokukaihei 11-183937/1999 (published on Jul. 9, 1999)).

In any case, it is preferable that the medium A be a material which is optically isotropic when no electric field is applied, and which induce the optical modulation when an electric field is applied. Typically, it is preferable that the medium A be a material in which an orientational order of molecules or a molecule cluster is improved by electric field application.

Further, it is preferable that the medium A be a material showing the Kerr effect. The material may be, for example, PLZT (Lead Zirconium Titanate, doped with a little lanthanum; La-modified lead zirconate titanate), or the like. Further, it is preferable that the medium A contain polar molecules. For example, nitrobenzene is suitable for the medium A.

The following description explains some examples of the mediums which can be used for the dielectric material layer 3 of the present display element.

### EXAMPLE 1

### Cubic Phase

It is possible to use a medium made of molecules expressing a cubic phase, as the medium injected and sealed in the dielectric material layer 3 of the present display element.

The material expressing the cubic phase is, for example, BABH8. BABH8 is in the cubic phase in a wide temperature range from 136.7° C. to 161° C., and the stable voltage transmissivity curve can be obtained in the wide temperature range (about 24K). Therefore, it is extremely easy to carry out the temperature control.

If an electric field is applied to the dielectric material layer 3 made of BABH8 when within the temperature range that BABH8 expresses the cubic phase, the molecules tends to turn in the electric field direction because the molecules have dielectric anisotropy. This causes a distortion of the structure of the minute regions (crystal-like grating). In other words, the dielectric material layer becomes optical anisotropic according to the electric field application.

Therefore, BABH8 can be used as the medium injected and sealed in the dielectric material layer 3. However, the present invention is not limited to this. Any medium expressing the cubic phase may be used as the medium injected and sealed in the dielectric material layer 3 because the optical anisotropy varies depending on whether a voltage is applied thereto or not.

### EXAMPLE 2

### Smectic D Phase (SmD)

As the medium injected and sealed in the dielectric material layer 3 of the present display element, it is possible to apply a medium which is made of molecules in the smectic D phase which is one of the liquid crystal phases.

One example of liquid crystal materials in the smectic D phase is ANBC16. Note that, ANBC16 is mentioned in Non-patent Document 1 (Kazuya Saito, and Michio Sorai, “Thermodynamics of a unique thermo-tropic liquid crystal having optical isotropy”, Ekisho, 2001, Vol. 5, No. 1 (p.21, FIG.1, Structure 1 (n=16)) and Non-patent Document 6 (“Handbook of Liquid Crystals”, Wiley-VCH, 1998, vol. 2B (p.888, Table 1, Compound No. 1, Compound 1a, Compound 1a-1)). The example includes ANBC etc. represented by the following chemical formulas (2) and (3).

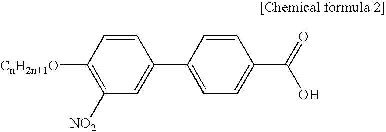

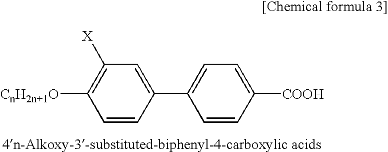

4′n-alkoxy-3′-nitro-biphenyl-4-carboxylic acids X═NO2

n-15 Cr 127 SmC 187 Cub 198 SmA 2041 I

The liquid crystal material (ANBC16) is in the smectic D phase in a temperature range from 171.0° C. to 197.2° C. In the smectic D phase, a plurality of molecules form a three-dimensional grating like a jungle gym®, and its grating constant is smaller than the optical wavelength. That is, the smectic D phase has the orderly structure showing a cubic symmetry. Therefore, the smectic D phase shows optical isotropy.

Moreover, when an electric field is applied to the dielectric material layer 3 made of ANBC16 in the above temperature range in which ANBC16 shows the smectic D phase, molecules tend to change their directions to the direction of the electric field because the molecules have dielectric anisotropy. As a result, the grating structure is distorted. That is, the dielectric material layer 3 expresses the optical anisotropy.

Therefore, it is possible to apply ANBC16 as the medium injected and sealed in the dielectric material layer 3 of the present display element. Note that, not only ANBC16 but also materials showing the smectic D phase are applicable as the medium injected and sealed in the dielectric material layer 3 of the present display element, because the optical anisotropy is varied depending on whether or not an electric field is applied.

### EXAMPLE 3

### Liquid Crystal Microemulsion

It is possible to apply a liquid crystal microemulsion as the medium injected and sealed in the dielectric material layer 3 of the present display element. The liquid crystal microemulsion is a generic term (named by Yamamoto, et al.) for a system (mixture system) in which oil molecules of O/W type microemulsion (a system in which droplet-shape water is dissolved in oil (continuous phase) by surfactant) are replaced with thermotropic liquid crystal molecules (see Non-patent Document 2: Jun Yamamoto, “Liquid crystal micro emulsion”, Liquid crystal, 2000, Vol. 4, No. 3, pp.248-254).

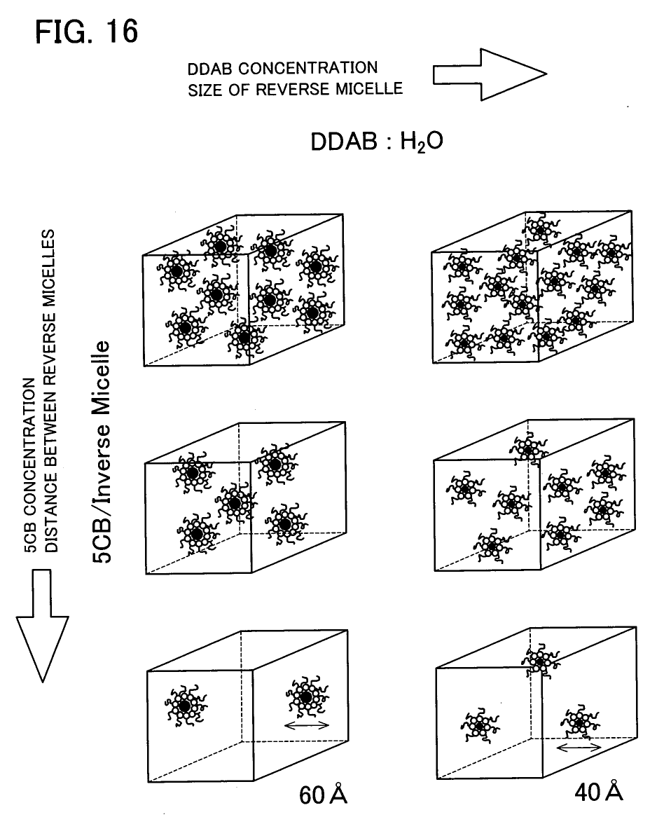

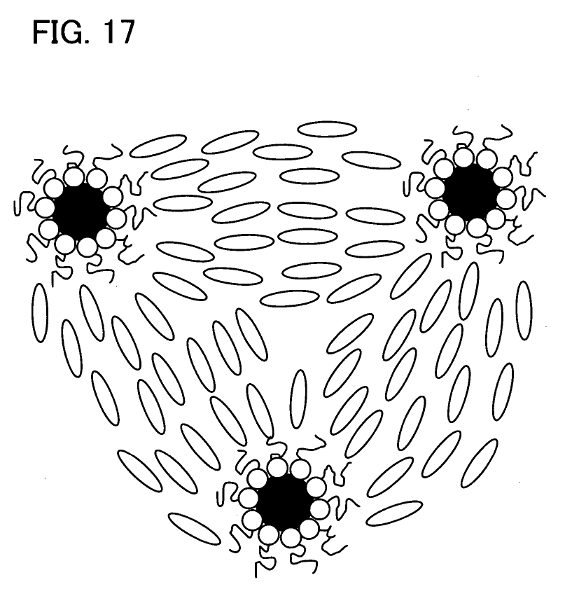

A concrete example of the liquid crystal microemulsion is a mixture system of pentylcyanobiphenyl (5CB) mentioned in Non-patent Document 2 and didodecyl ammonium bromide (DDAB) solution. Pentylcyanobiphenyl (5CB) is a thermotropic liquid crystal (temperature transition type liquid crystal) showing a nematic liquid crystal phase, and didodecyl ammonium bromide (DDAB) is a lyotropic liquid crystal (concentration transition type liquid crystal) showing a reverse micelle phase. This mixture system has a structure illustrated by schematic views of FIGS. 16 and 17.

According to the above mixture system, a diameter of a reverse micelle is about 50 Å, and a distance between reverse micelles is about 200 Å. Each of these scales is approximately one tenth of the optical wavelength. The reverse micelles randomly exist in a three-dimensional space, and 5CBs are aligned in a radial pattern centering on each reverse micelle. Therefore, the above mixture system is optically isotropic.

When an electric field is applied to a medium made of the above mixture system, its molecules tend to change their directions to the direction of the electric field because 5CB has dielectric anisotropy. That is, although a system is optically isotropic because 5CBs are aligned in a radial pattern centering on the reverse micelle, alignment anisotropy is expressed, so that the optical anisotropy is expressed. Therefore, it is possible to apply the above mixture system as the medium injected and sealed in the dielectric material layer 3 of the present display element. Note that, the medium is not limited to the above mixture system. As long as the optical anisotropy of the liquid crystal microemulsion is changed depending on whether or not an electric field is applied, it is possible to apply the liquid crystal microemulsion as the medium injected and sealed in the dielectric material layer 3 of the present display element.

### EXAMPLE 4

### Lyotropic Liquid Crystal Phase

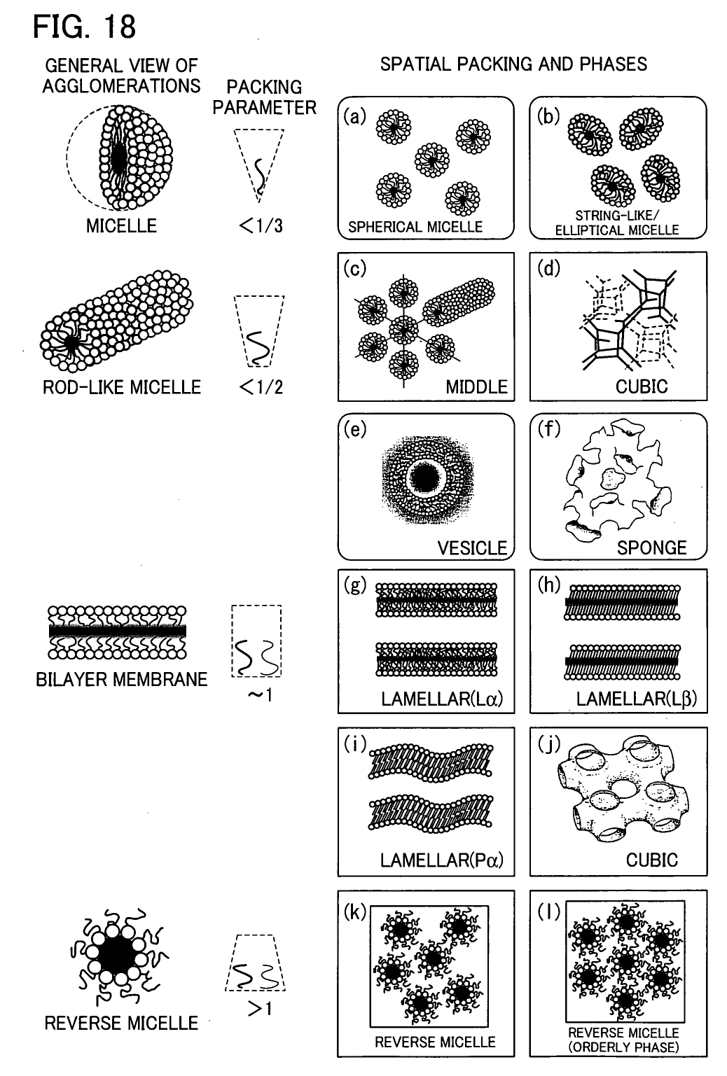

As the medium injected and sealed in the dielectric material layer 3 of the present display element, it is possible to apply the lyotropic liquid crystal in a specific phase. The lyotropic liquid crystal is generally a multicomponent system liquid crystal in which main molecules constituting a liquid crystal are dissolved in a solvent (water, organic solvent, or the like) having different properties. Moreover, the above specific phase is a phase in which the magnitude of the optical anisotropy is changed depending on whether or not an electric field is applied. Examples of such specific phases are micelle phase, sponge phase, cubic phase, and reverse micelle phase, which are described in Non-patent Document 7 (Jun Yamamoto “First lecture of liquid crystal science experiment: Identification of liquid crystal phase: (4) Lyotropic liquid crystal”, Liquid crystal, 2002, Vol. 6, No. 1, pp.72-82). FIG. 18 illustrates classification of the lyotropic liquid crystal phases.

Some of surfactants, which are amphiphilic materials, express the micelle phase. For example, an aqueous solution of sodium dodecyl sulfate and an aqueous solution of potassium palmitin acid, which are ionic surfactants, constitute spherical micelles. In mixture liquid obtained by mixing polyoxyethylene nonylphenyl ether, which is a non-ionic surfactant, with water, a nonylphenyl group functions as a hydrophobic group and oxyethylene chain functions as a hydrophilic group, so that micelles are formed. An aqueous solution of styrene-ethyleneoxideblock copolymer also constitutes micelles.

For example, the spherical micelle becomes globular by packing molecules in all spatial directions (by forming a molecular assembly). The size of the spherical micelle is smaller than the optical wavelength, so that the spherical micelle seems not anisotropic but isotropic in the optical wavelength region. However, when an electric field is applied to such spherical micelle, the spherical micelle is distorted, so that anisotropy is expressed. Therefore, it is possible to apply the lyotropic liquid crystal in the spherical micelle phase as the medium injected and sealed in the dielectric material layer 3 of the present display element. Note that, not only the lyotropic liquid crystal in the spherical micelle phase but also the lyotropic liquid crystal in other types of micelle phases such as string-type micelle phase, ellipse-type micelle phase, rod-like micelle phase can be used as the medium injected and sealed in the dielectric material layer 3 in order to obtain substantially the same effects.

Moreover, it is well-known that the reverse micelle in which the hydrophilic group and the hydrophobic group are replaced with each other is formed depending on conditions of concentration, temperature, and surfactant. Such reverse micelle optically shows the same effects as the micelle. Therefore, when the lyotropic liquid crystal in the reverse micelle phase is applied as the medium injected and sealed in the dielectric material layer 3, it is possible to obtain effects equivalent to effects obtained in a case where the lyotropic liquid crystal in the micelle phase is used. Note that, the liquid crystal microemulsion explained in Example 3 is one example of the lyotropic liquid crystals having the reverse micelle phase (reverse micelle structure).

Moreover, in a certain concentration and a temperature range, an aqueous solution of pentaethyleneglycol-dodecylether (C₁₂E₅), which is a non-ionic surfactant, shows the sponge phase or the cubic phase illustrated in FIG. 18. Such sponge phase and cubic phase have an order which is smaller than the optical wavelength, so that the materials are transparent in the optical wavelength region. That is, the medium having these phases is optically isotropic. When an electric field is applied to the medium having these phases, the orientational order (order structure) is distorted and the optical anisotropy is expressed. Therefore, the lyotropic liquid crystal in the sponge phase or in the cubic phase can be applied as the medium injected and sealed in the dielectric material layer 3 of the present display element.

### EXAMPLE 5

### Liquid Crystal Fine Particle Dispersal System

For example, as the medium injected and sealed in the dielectric material layer 3 of the present display element it is possible to apply a liquid crystal fine particle dispersal system showing a phase (such as the micelle phase, the sponge phase, the cubic phase, and the reverse micelle phase) in which the magnitude of the optical anisotropy is changed depending on whether or not an electric field is applied. Here, the liquid crystal fine particle dispersal system is a mixture system in which fine particles are mixed in a solvent (liquid crystal). (See Non-patent Document 3: Yukihide Shiraishi, et al, “Palladium nano particle protected by liquid crystal molecule—Preparation and application to guest-host mode liquid crystal display element”, Collected papers on polymer, December, 2002, Vol. 59, No. 12, pp.753-759.))

An example of the liquid crystal fine particle dispersal system is a liquid crystal fine particle dispersal system in which an aqueous solution of pentaethyleneglycol-dodecylether (C12E5), which is a non-ionic surfactant, is mixed with latex particles, having surfaces modified by a sulfuric acid group, each of which has a diameter of about 100 Å. The liquid crystal fine particle dispersal system expresses the sponge phase. Moreover, the orientational order (order structure) of the sponge phase is smaller than the optical wavelength. Therefore, as in Example 4, it is possible to apply the liquid crystal fine particle dispersal system as the medium injected and sealed in the dielectric material layer 3 of the present display element.

Note that, instead of using the latex particles, DDAB can be used to obtain the same alignment structure as the structure of the liquid crystal microemulsion described in Example 3.

### EXAMPLE 6

### Dendrimer

As the medium injected and sealed in the dielectric material layer 3 of the present display element, it is possible to apply a dendrimer (a dendrimer molecule). Here, the dendrimer is a three-dimensional highly-branched polymer which has a branch per monomer unit.

The dendrimer has a lot of branches. Therefore, when the molecular weight exceeds a certain level, the dendrimer becomes a globular structure. The globular structure has an order which is smaller than the optical wavelength, so that the material is transparent in the optical wavelength region. When an electric field is applied, the magnitude of the alignment order is changed and the optical anisotropy is expressed. Therefore, it is possible to apply the dendrimer as the medium injected and sealed in the dielectric material layer 3 of the present display element.

Moreover, in the liquid crystal microemulsion described in Example 3, instead of using DDAB, the dendrimer can be used to obtain the same alignment structure as the structure of the liquid crystal microemulsion. It is possible to apply the dendrimer as the medium injected and sealed in the dielectric material layer 3 of the present display element.

### EXAMPLE 7

### Cholesteric Blue Phase

As the medium injected and sealed in the dielectric material layer 3 of the present display element, it is possible to apply a medium made of molecules in a cholesteric blue phase. Note that, FIG. 18 schematically illustrates a structure of the cholesteric blue phase.

As illustrated in FIG. 11, the structure of the cholesteric blue phase is highly symmetric. The cholesteric blue phase has an order which is smaller than the optical wavelength, so that the material is almost transparent in the optical wavelength region. When an electric field is applied, the alignment order is changed and the optical anisotropy is expressed (the magnitude of the optical anisotropy changes). That is, the cholestric blue phase is optically almost isotropic. When an electric field is applied to the cholestric blue phase, its liquid crystal molecules tend to change their directions to the direction of the electric field, so that the grating is distorted and the anisotropy is expressed. Therefore, it is possible to apply a medium made of molecules in the cholesteric blue phase as the medium injected and sealed in the dielectric material layer 3 of the present display element.

Note that, as an example of a material in the cholesteric blue phase, it is possible to use a material which is formed by mixing 48.2 mol % of JC1041 (mixture liquid crystal produced by CHISSO), 47.4 mol % of 5CB (4-cyano-4′-pentyl biphenyl, nematic liquid crystal), and 4.4 mol % of ZLI-4572 (chiral dopant produced by MERCK). The material shows the cholesteric blue phase in a temperature range from 330.7K to 331.8K.

### EXAMPLE 8

### Smectic Blue (BPsm) Phase

As the medium injected and sealed in the dielectric material layer 3 of the present display element, it is possible to apply a medium made of molecules in a smectic blue (BPsm) phase (see Non-patent Document 5: Makoto Yoneya, “Examining nano-structured liquid crystal phase by molecule simulator”, Liquid crystal, 2003, Vol. 7, No. 3, pp. 238-245). Note that, FIG. 18 schematically illustrates a structure of the smectic blue phase.

As illustrated in FIG. 18, like the cholesteric blue phase, the structure of the smectic blue phase is highly symmetric. The smectic blue phase has an order which is smaller than the optical wavelength, so that the material is almost transparent in the optical wavelength region. When an electric field is applied, the magnitude of the alignment order is changed and the optical anisotropy is expressed (the magnitude of the optical anisotropy changes). That is, the smectic blue phase is optically almost isotropic. When an electric field is applied to the smectic blue phase, its liquid crystal molecules tend to change their directions to the direction of the electric field, so that the grating is distorted and the anisotropy is expressed. Therefore, it is possible to apply a medium made of molecules in the smectic blue phase as the medium injected and sealed in the dielectric material layer 3 of the present display element.

Note that, an example of a material in the smectic blue phase is FH/FH/HH-14BTMHC described in Non-patent Document 10 (Eric Grelet, et al, “Structural Investigations on Smectic Blue Phases”, PHYSICAL REVIEW LETTERS, The American Physical Society, Apr. 23, 2001, vol. 86, No. 17, pp.3791-3794). The material shows a BPsm 3 phase in a temperature range from 74.4° C. to 73.2° C., a BPsm 2 phase in a temperature range from 73.2° C. to 72.3° C., a BPsm 1 phase in a temperature range from 72.3° C. to 72.1° C.

### [Second Embodiment]

In a display element of the present embodiment, a material injected and sealed in the dielectric material layer 3 was 4′-n-alkoxy-3′-nitrobiphenyl-4-carboxylic acids (ANBC-22), which is a transparent dielectric material.

Note that the substrates 1 and 2 were glass substrates, and a distance therebetween was set to 4 μm by dispersing beads in advance. In other words, a thickness of the dielectric material layer 3 was set to 4 μm.

Further, the comb-shaped electrodes 4 and 5 were transparent electrodes made of ITO (indium tin oxide). On the respective inner sides (counter surfaces) of the substrates 1 and 2, alignment films that were made of polyimide, and that had been subjected to a rubbing process were provided. It is preferable that a rubbing direction be such a direction that the present display element is in a bright state when the material is in the smectic C phase. Typically, it is preferable that the rubbing direction creates a 45° angle with respect to the axis direction of the polarizers. Note that the alignment film for the substrate 1 is formed so as to cover the comb-shaped electrodes 4 and 5.

As shown in FIG. 2, the polarizers 6 and 7 were provided on the respective outer surfaces (the other side of the counter surface) of the substrates 1 and 2 in such a manner that their absorption axes were orthogonal to each other, and that a 45° angle was created between (i) the absorption axes and (ii) a direction of extension of the comb tooth portions of the electrodes 4 and 5.

When the display element thus obtained is at a temperature lower than a smectic C phase/cubic phase transition temperature, the material is in the smectic C phase. The material in the smectic C phase is optically anisotropic under no applied voltage.

The display element was maintained at a temperature in the vicinity of the smectic C phase/cubic phase transition temperature (specifically, maintained at a temperature approximately 10 K below the phase transition temperature) with the use of an external heating apparatus, and a voltage (alternating electric field of about 50 V, a frequency greater than 0 Hz and no more than several hundred kHz) was applied. This caused a change in the transmittance of the display element. In other words, the voltage application caused a phase transition from (i) the smectic C phase (bright state), in which the material is optically anisotropic under no applied voltage, to (ii) the cubic phase (dark state) in which the material is optically isotropic.

Note that the angle made by the absorption axes of the polarizers and the comb-shaped electrodes is not just limited to 45°. In fact, display was successfully carried out at any angle between 0° and 90°. This is for the following reasons. That is, because the bright state is attained when no voltage is applied, the bright state can be attained merely by the relation between the rubbing direction and the absorption axes of the polarizers. Moreover, the dark state is attained through that electric-field-induced phase transition of the medium to the optically isotropic phase. Therefore, irrespective of the relation between (i) the absorption axes of the polarizers and (ii) the direction of the comb-shaped electrodes, the dark state can be attained as long as the absorption axes are orthogonal to each other. Therefore, the alignment process is not necessarily required, and display was successfully carried out even in the case where the material was in an amorphous alignment state (random alignment state).

Note also that in the case where the electrodes were provided on the substrates 1 and 2 respectively and an electric field was generated in a direction normal to the surfaces of the substrates 1 and 2, substantially the same result was obtained. In other words, the electric field application in the normal direction produced the substantially the same result as the electric field application in a horizontal direction along the surfaces of the substrates 1 and 2 did.

As such, the medium injected and sealed in the dielectric material layer 3 of the present display element may be a medium which shows optical anisotropy when no voltage is applied, and which loses the optical anisotropy and shows optical isotropy by electric field application.

Note that the medium used for the dielectric material layer 3 of the present display element may have positive dielectric anisotropy or negative dielectric anisotropy. Media having negative dielectric anisotropy are exemplified in the following chemical formula 4.

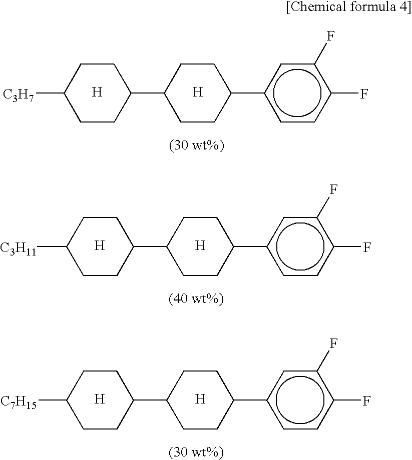

In cases where the medium has positive dielectric anisotropy, an electric field substantially parallel to the substrates is required for the driving of the display element. However, in cases where the medium has negative dielectric isotropy, there is no such restriction. For example, both an electric field oblique to the substrate and an electric field perpendicular to the substrate enable driving of the display element. In these cases, the electrodes are provided on both of the pair of substrates (substrates 1 and 2) in the present display element. By applying an electric field to a region between the electrodes provided on both of the substrates, an electric field can be applied to the dielectric material layer 3.

Note that, depending on whether an electric field is applied parallel, perpendicular, or oblique to the surfaces of the substrates, the shape, material, number, or position etc. of the electrodes can be suitably changed. For example, transparent electrodes may be used and an electric field may be applied perpendicular to the surfaces of the substrates. This is advantageous in terms of open area ratio.

As described above, a display element of the present invention includes a pair of substrates, at least one of which is transparent; a medium, between the substrates, the medium being changeable in an optical anisotropy magnitude by and according to electric field application; and a region in which a pixel electrode and a counter electrode overlap with each other with an insulating layer therebetween.

With the arrangement, a display apparatus including the display element never loses the high-speed response property faster than the response property of the conventional liquid crystal display elements. This allows more secure realization of the high-speed response of the display element that carries out a display by using the change of the medium in terms of magnitude of optical anisotropy.

Further, in the case where the auxiliary capacitor is formed as in the arrangement, it is possible to supply, from the auxiliary capacitor to the medium, an electric charge that corresponds to an electric charge in short (that is, the auxiliary capacitor can supply, to the medium of a part of the screen with which the auxiliary capacitor is associated, electric charge necessary for making up for short of electric charge in the medium). This apparently prevents the decrease in the specific resistance of the medium, and allows an appropriate voltage to be applied to the medium. On this account, it is possible to prevent the decrease in luminance and the unevenness in luminance.

Further, the display element is preferably arranged so that the pixel electrode and the counter electrode apply an electric field to the medium. This prevents a decrease in the open area ratio of the display element, and allows formation of a larger auxiliary capacitor.

Further, a display element of the present invention includes: a pair of substrates, at least one of which is transparent; and a medium, between the substrates, the medium being changeable in an optical anisotropy magnitude by and according to electric field application, an auxiliary capacitor being formed parallel to a capacitor of the display element.

Further, it is preferable that the display element of the present invention further includes: a first electrode and a second electrode for generating the electric field by a voltage applied onto the first electrode and the second electrode. Further, the display element of the present invention is preferably arranged so that the first electrode and the second electrode be provided on an opposing surface of one of the substrates, the opposing surface facing the other substrate.

With this arrangement, an electric field can be applied to the dielectric material layer, thereby causing a change in magnitude of optical anisotropy of the medium.

It is preferable that the display element include a switching element, connected to one of the first electrode and the second electrode, for switching ON and OFF of electrical connection of the one of the first electrode and the second electrode. In such a display element thus arranged, the aforementioned problems tend to occur especially in the case of using the medium whose optical anisotropy varies according to electric field application. Therefore, in this case, the formation of the auxiliary capacitor shows a large effect.

The following description explains why the aforementioned problems tend to occur in the display element thus arranged. In the display element, turning ON and OFF of the switching element causes discharge of an electric charge stored in the pixel at a time constant of: Cp×Rp where Cp indicates that capacitance of the pixel capacitor which is formed by the medium, and Rp indicates resistance thereof. Therefore, when Rp has a small value, the decrease in a voltage in the pixel is great, thereby causing deficiency in a display.

Here, the auxiliary capacitor is formed parallel to the pixel. The auxiliary capacitor has capacitance Cs. The auxiliary capacitor can be formed by using a material having large specific resistance, such as a material like an inorganic thin film having less impurity or an organic thin film. Therefore, the auxiliary capacitor has a value (ideally, infinity) which is much larger than Rp of the pixel and which is so large that Rp of the pixel can be ignored. The time constant when adding the auxiliary capacitor is: (Cp+Cs)×Rp, and therefore can be increased by Cs. This causes time for discharge of electricity to be longer, and allows prevention of the decrease in a voltage, thereby improving the deficiency in a display.

The display element is preferably arranged so that the auxiliary electrode overlies on the at least one of the first electrode and the second electrode. Here, the auxiliary electrode refers to an electrode newly provided for formation of the auxiliary capacitance.

With this arrangement, the auxiliary capacitor can be formed by using the electrodes for applying an electric field to the display element. This allows simplification of the structure of the display element and simplification of a manufacturing process. Moreover, because the auxiliary electrode overlies the electrode having been already provided, no region allowing light to pass through is reduced (i.e., open area ratio is not reduced) in the display element. This secures brightness in a display.

The display element is preferably arranged so that the auxiliary electrode overlies on the at least one of the first electrode and the second electrode so that it is kept within a formation region of the at least one of the first electrode and the second electrode. With this arrangement, the auxiliary capacitor can be formed within the formation region of the electrode for applying an electric field to the display element. This prevents reduction of the portion allowing light to pass through in the display element, and secures brightness in a display.

The auxiliary electrode may be connected to the first electrode or the second electrode, which is not overlaid by the auxiliary electrode. With this arrangement, the capacitor of the display element and the auxiliary capacitor can be formed by wiring for the first and the second electrodes. This allows simplification of the structure of the display element and simplification of the manufacturing process.

The display element is characterized in that the auxiliary electrode is provided between (a) the substrate and (b) the first and/or the second electrodes provided on the surface of the substrate. With this arrangement, the auxiliary electrode is formed on an outer side than the electrode for applying an electric field to the medium. On this account, the auxiliary capacitor can be formed while preventing an adverse effect on the display quality of the display element.

It is preferable that a ratio between (a) a capacitance value of the display element when no electric field is applied and (b) a capacitance value of the auxiliary capacitor is 1:1 or greater. It is more preferable that a ratio between (a) a capacitance value of the display element when no electric field is applied and (b) a capacitance value of the auxiliary capacitor is 1:2 or greater.

By setting the value of the auxiliary capacitor, it is possible to desirably prevent the foregoing problems such as the decrease in transmittance of the display element, the unevenness in luminance, and the decrease in the response speed.

The medium may show Kerr effect.

The medium may contain a liquid crystalline material.

The medium may contain a polar molecule.

The medium may be made of a material whose orientational order parameter is varies according to electric field application.

The medium may be made of a material whose refractive index varies according to electric field application.

The medium may have an orderly structure which shows a cubic symmetric property.

The medium may be made of molecules showing a cubic phase or a smectic D phase.

The medium may be made of liquid crystal microemulsion.

The medium may be made of lyotropic liquid crystal showing any one of a micelle phase, a reverse micelle phase, a sponge phase, and a cubic phase.

The medium may be made of liquid-crystal-fine-particle dispersal system showing any one of a micelle phase, a reverse micelle phase, a sponge phase, and a cubic phase.

The medium may be made of dendrimer.

The medium may be made of molecules showing a cholesteric blue phase.

The medium may be made of molecules showing a smectic blue phase.

Each of the materials described above has optical anisotropy which varies according to electric field application. Therefore, the materials can be used as the medium injected and sealed in the dielectric liquid layer of the display element of the present invention.

The medium may show the optical anisotropy when an electric field is not applied, and the medium may show optical isotropy when an electric field is applied.

Further, a display apparatus of the present invention includes the display element described above. Because the display element includes the auxiliary capacitor, the aforementioned effects can be shown.

Note that the present invention may be arranged as follows.

A first display element in which a medium, which is optically isotropic when no voltage is applied, is interposed between a pair of substrates, at least one of which is transparent, the first display element being driven according to an electric field applied via a switching element, the first display element including: an auxiliary capacitor formed parallel to a pixel capacitor in an equivalent circuit.

A second display element, obtained by providing first and second electrodes on one of the substrate of the first display element, the medium being optically anisotropic when an electric field is formed, substantially parallel to the substrates, between the first and second electrodes, wherein: an auxiliary capacitor is provided under the first electrode or the second electrode.

A third display element, obtained by connecting the first electrode to a switching element in the second display element, wherein: an auxiliary capacitor is formed under the first electrode.

A display element, wherein: the first or the second display element has the auxiliary capacitor whose capacitance is at least as large as or larger than capacitance of a pixel capacitor when a pixel is OFF.

A display element, wherein: the first or second display element has the auxiliary capacitor whose capacitance is at least twice as large as capacitance of a pixel capacitor when a pixel is OFF.

Further, the display element of the present invention may be so arranged that the first and the second electrodes are provided on an opposing surface of one of the substrates, the opposing surface facing the other substrate.

The present invention is not limited to the embodiments above, but may be altered within the scope of the claims. An embodiment based on a proper combination of technical means disclosed in different embodiments is encompassed in the technical scope of the present invention.

1. A display element comprising:
a pair of substrates, at least one of which is transparent;
a medium, between the substrates, the medium being changeable in an optical anisotropy magnitude by and according to electric field application; and
a region in which a pixel electrode and a counter electrode overlap with each other with an insulating layer therebetween.

2. The display element as set forth in claim 1, wherein:
the pixel electrode and the counter electrode apply an electric field to the medium.

3. A display element comprising:
a pair of substrates, at least one of which is transparent; and
a medium, between the substrates, the medium being changeable in an optical anisotropy magnitude by and according to electric field application
an auxiliary capacitor being formed parallel to a capacitor of the display element.

4. The display element as set forth in claim 3, further comprising:
a first electrode and a second electrode for generating the electric field by a voltage applied onto the first electrode and the second electrode.

5. The display element as set forth in claim 4, comprising:
a switching element, connected to one of the first electrode and the second electrode, for switching ON and OFF of electrical connection of the one of the first electrode and the second electrode.

6. The display element as set forth in claim 4, wherein:
the first electrode and the second electrode are provided on an opposing surface of one of the substrates, the opposing surface facing the other substrate.

7. The display element as set forth in claim 4, wherein:
an auxiliary electrode is so provided as to overlie at least one of the first electrode and the second electrode so as to form the auxiliary capacitor.

8. The display element as set forth in claim 7, wherein:
the auxiliary electrode overlies on the at least one of the first electrode and the second electrode so that it is kept within a formation region of the at least one of the first electrode and the second electrode.

9. The display element as set forth in claim 4, wherein:
the auxiliary electrode is connected to one of the first electrode of the second electrode which is not overlaid by the auxiliary electrode.

10. The display element as set forth in claim 4, wherein:
the auxiliary electrode is provided between (a) the substrate and (b) the first and/or the second electrodes provided on the surface of the substrate.

11. The display element as set forth in claim 3, wherein:
a ratio between (a) a capacitance value of the display element when no electric field is applied and (b) a capacitance value of the auxiliary capacitor is 1:1 or greater.

12. The display element as set forth in claim 3, wherein:
a ratio between (a) a capacitance value of the display element when no electric field is applied and (b) a capacitance value of the auxiliary capacitor is 1:2 or greater.

13. The display element as set forth in claim 1, wherein:
the medium is a material that shows Kerr effect.

14. The display element as set forth in claim 1, wherein:
the medium contains a liquid crystalline material.

15. The display element as set forth in claim 1, wherein:
the medium contains a polar molecule.

16. The display element as set forth in claim 1, wherein:
the medium is made of a material whose orientational order parameter is varies according to electric field-application.

17. The display element as set forth in claim 1, wherein:
the medium is made of a material whose refractive index varies according to electric field application.

18. The display element as set forth in claim 1, wherein:
the medium has an orderly structure which shows a cubic symmetric property.

19. The display element as set forth in claim 1, wherein the medium is made of molecules showing a cubic phase or a smectic D phase.

20. The display element as set forth in claim 1, wherein the medium is made of liquid crystal microemulsion.

21. The display element as set forth in claim 1, wherein the medium is made of lyotropic liquid crystal showing any one of a micelle phase, a reverse micelle phase, a sponge phase, and a cubic phase.

22. The display element as set forth in claim 1, wherein the medium is made of liquid-crystal-fine-particle dispersal system showing any one of a micelle phase, a reverse micelle phase, a sponge phase, and a cubic phase.

23. The display element as set forth in claim 1, wherein the medium is made of dendrimer.

24. The display element as set forth in claim 1, wherein the medium is made of molecules showing a cholesteric blue phase.

25. The display element as set forth in claim 1, wherein the medium is made of molecules showing a smectic blue phase.

26. The display element as set forth in claim 1, wherein:
the medium shows the optical anisotropy when an electric field is not applied, and
the medium shows optical isotropy when an electric field is applied.

27. A display apparatus, comprising a display element,
the display element including:
a pair of substrates, at least one of which is transparent;
a medium, between the substrates, the medium being changeable in an optical anisotropy magnitude by and according to electric field application; and
a region in which a pixel electrode and a counter electrode overlap with each other with an insulating layer therebetween.

28. A display apparatus, comprising a display element,
the display element including:
a pair of substrates, at least one of which is transparent; and
a medium, between the substrates, the medium being changeable in an optical anisotropy magnitude by and according to electric field application,
an auxiliary capacitor being formed parallel to a capacitor of the display element.
